(19) United States
(12) Patent Application Publication
(10) Pub. No.: US 2005/0187851 A1
(43) Pub. Date: Aug. 25, 2005

(54) Financial portfolio management and analysis system and method

(75) Inventor: Rajiv Raymond Sant, Round Rock, TX (US)

Correspondence Address: FULBRIGHT & JAWORSKI, LLP, 1301 MCKINNEY, SUITE 5100, HOUSTON, TX, 77010-3095, US

(73) Assignee: FINSAGE INC., Round Rock, TX (US)

(21) Appl. No.: 10/959,741

(22) Filed: Oct. 6, 2004

Related U.S. Application Data
(60) Provisional application No. 60/509,641, filed on Oct. 8, 2003.

(51) Int. Cl. G06F 17/60

(52) U.S. Cl. 705/36

(57) ABSTRACT

The invention relates generally to a system and method of financial portfolio management and analysis. More particularly, the invention is directed to a system and computer-implemented method is provided for analyzing financial assets and performing asset valuation, statistical, econometric and portfolio analysis. The system includes various modules including: Time value of money, Loan and Lease Rate Tools, Stock Valuation Modules, Bond Valuation Modules, Portfolio Analysis Modules, Risk Return Tradeoff, IPO (Initial Public Offering) Simulator, Announcement Effect or Event Effect Simulator, Option Valuation, Option Volatility, Forward Simulation with Probabilities, and Gain/Loss Probability Estimator.

This application claims priority to U.S. App. Ser. No. 60/509,641 filed Oct. 8, 2003.

### BACKGROUND OF THE INVENTION

The present invention relates generally to a system and method of financial portfolio management and analysis. More particularly, the present invention is directed to a system and computer-implemented method is provided for analyzing financial assets and performing asset valuation, statistical, econometric and portfolio analysis. The system includes various modules including: Time value of money, Loan and Lease Rate Tools, Stock Valuation Modules, Bond Valuation Modules, Portfolio Analysis Modules, Risk Return Tradeoff, IPO (Initial Public Offering) Simulator, Announcement Effect or Event Effect Simulator, Option Valuation, Option Volatility, Forward Simulation with Probabilities, and Gain/Loss Probability Estimator. The system includes a computer, database accessible by the computer and having stored thereon historical and real time data relating to a financial asset, and software executing on the computer for generating and displaying various analyses.

### BRIEF SUMMARY OF THE INVENTION

Investment Process for Portfolio Creation, Validation, Efficiency and Loss Tolerance Determination: There are several approaches to investment management. A typical approach requires an investor to create an investment policy focused on a set of goals as defined by return requirement and the investor's tolerance for risk. Investment strategies consistent with any set of goals require an estimation of an investment's return measures and risk parameters. With the increase in data availability and faster computational resources, a set of Web-based software tools enable the implementation of investment strategies in a “test before you invest” setting.

This implementation consists of the steps of: (1) identify a set of stocks that meet defined criteria and satisfy the investor's goals and value the stocks on the basis of their risk and return parameters and future growth expectations; (2) conduct back-testing and life-of portfolio performance—back-testing is conducted on the basis of past returns to analyze the appropriateness of the selected portfolio of stocks for meeting the investor's objectives and life-of-portfolio analysis is an attempt at verification and validation of the results of the back-test, the latter relying upon observation of portfolio performance in real time after the date of creation but before actually investing in the portfolio; (3) analyze the risk-return relationship of the portfolio by simulating thousands of portfolios with the same set of securities by changing the portfolio weights, and making comparisons among them to identify the best security allocations needed for achieving a portfolio of desired risk level offering the highest estimated return in the future; and (4) analyze the portfolio risk by estimating objective probability of a specified loss over a given period on the basis of distributional assumptions, as well as a breakdown of the loss according to component securities to assess risk concentration in a sector or sub-set of securities. If the estimated probability of loss is excessive or inconsistent with the risk tolerance capacity of the user, a new portfolio strategy is developed by going back to step 1. While past performance is not a guarantee of future performance, historical analysis using actual security prices enables an investor to identify risk characteristics of investments that are known to be relatively stable at the portfolio level. The goal of the investment process described herein is to identify an optimal portfolio that meets an investor's return objectives within the risk tolerance of the investor. It helps the user analyze potential risk scenarios and their impact on user's wealth. The portfolio creation and optimization process, along with its sub-processes and feedback loops, is shown in FIG. 81.

Implementation of portfolio creation process is an iterative search for the best portfolio, which is also known as the efficient portfolio as defined by its risk and return characteristics. An efficient portfolio is defined as that portfolio among a set of all feasible portfolios constructed with the same set of underlying securities and differ only in terms of the portfolio proportions invested in different securities, that offers the highest expected return for a given level risk. Alternatively, an efficient portfolio can be defined as that portfolio that has the lowest risk level for a given return expectation. The software tools identify the frontier of efficient portfolios (corresponding to different risk levels) so as to enable the investor to identify the portfolio best suited to his or her needs. The life-of-portfolio analysis can be also be employed after an optimal portfolio has been identified so as to monitor it real time performance. The following modules, described in this utility, constitute the described Investment Process for Portfolio Creation, Validation, Efficiency and Loss Tolerance Determination process.
Stock Screener and Stock Valuation Modules
Portfolio Strategy Analysis Modules
Portfolio Risk Return Tradeoff Module
Gain/Loss Probability Estimator Module

This process can also be employed for analyzing the success of investing in sector or industry portfolios as well as asset allocation strategies based on large, medium, and small size stocks in combination with value and growth investing styles.

Option valuation and risk evaluation process: Options are rights or privileges to purchase and sell securities at a specified price over a specified period. They are derived instruments and are commonly used for risk management purposes. Due to the inherent leverage, they are also very risky securities. While that are simple to understand and are frequently used in every day life, such as a rain-check from a retail store, they are extremely difficult to value due to the asymmetric nature of their payoff. If the holder of an option does not find in his or her interest to exercise the option, the option is discarded and has a value of zero. On the other, if the holder finds it worthwhile to exercise the option, the option has a positive non-zero value. Option valuation and investing requires an understanding of the simple fact that these instruments price one segment of a probability distribution unlike stocks which value an entire distribution.

Web-based option software tools enable an investor to value European and American options. European options can be exercised only on the expiration date, whereas American type options can be exercised any time during the tenure of the option. American options are, therefore, considerably harder to evaluate and require a great deal of computing resource. These software tools encompass both call (right to purchase) and put (right to sell) options. An investors uses option modules in the following process: (1) value options on the basis of specified exercise assumptions; (2) verify their volatility estimates; (3) project future option values over the tenure of the option; and (4) observe the risk management potential of the options by combining them with a portfolio of stocks and following their real time performance with the help of the life-of-portfolio component of the Portfolio Strategies Analysis Module.

While the option valuation modules (including the volatility module) enables a user to estimate the fair value of exchange traded (as well as non-traded) options, the forward simulation module enables the user to project payoff scenarios with objective probabilities, based on distributional assumptions for the underlying security returns. The forward simulation assists a user in assessing the likelihood of the option exceeding a target value in the future. This analysis is significant due to the fact that options are decaying assets. As time passes, even if underlying variables such as security prices and volatility remain unchanged, option values decline. This is unlike stocks. As a result, an understanding of the decay properties of an option is critical to a risk management strategy implemented with the help of options. In summary, this process enables a user to: value options; validate valuation with the help of implied volatility; and estimate option decay properties for their impact on a risk management strategy; and, simulate portfolio performance with the help of exchange traded securities and options comprising the investor's portfolio. This process employs the following software modules:
Option Valuation Module
Option Volatility Module
Forward Option Value Simulation with Probabilities Module
Portfolio Strategy Analysis Modules

The process described here-in is also adaptable to evaluation non-traded executive and employee incentive stock options. By identifying companies in the same industry which have exchange-traded options, an option holder can value his or her options by proxy with the help of the process discussed in this utility.

Announcement and event effect evaluation process: Investors often invest in stocks that have announced stock splits, merger and acquisition deals, earnings reports, executive hiring, promotions and resignations and a myriad of other company related events. Furthermore, they active invest in IPOs of new companies that have a no track record as a public company and whose stocks may be risky and even speculative. The announcement and event effect module enables a user to evaluate the general response of the market to different types of events outlined above. It informs the user of the average market response to such events and whether investing in stocks after the announcement has already been made or even already taken place is worthwhile. Investment process can be very complex and security prices react to new information continually. While markets anticipate information, the module captures the unanticipated or the surprise effect of the news. It enables an investor to decide whether to tailor the investment strategy towards such events or away from such events. Investing in stocks after they have split is one strategy often touted by investment advisory services. Whether this is a long-term or a short-term strategy is debated. Modules enable a user to see the exact effect of a certain type of announcement on a group of stocks all sharing a common event, such as takeover, and research the market's instantaneous and long-term reaction. This leads to better investment strategies since the analysis not only controls for the effects of market wide forces, it also adjusts for risk.

A similar analysis can be performed for initial public offerings (IPOs). There is considerable interest among investing public, especially small investors, to acquire shares in “hot” IPOs. This makes for opportunistic trading, pricing and allocations on the part of brokers. The decade of the nineties is replete with examples dotcom IPOs that were overpriced and subsequently crashed, causing investors steep losses. The IPO module enables a user to evaluate the market's average response to IPOs. IPOs may be grouped by issuer's industry, size of the IPO, price of the IPO etc. and analyzed for the issue date market response. Since the IPO does not have any trading history, risk estimates are derived from non-overlapping post-listing trading data. In both cases, corporate events and IPO analysis, the following process is implemented: (1) identification or selection of a dataset sharing a common event or news release; (2) selection of risk measure and market proxy for risk control; (3) analysis of announcement, event or listing day effect as well as longitudinal post event average performance; (4) repeating the process for several different investment strategies predicated on announcements, events and IPO segments to identify the most rewarding strategy; and, (5) real time tracking of a model portfolio implementing a strategy based on the previous steps, with the help of life-of portfolio module for its investment efficacy. The modules employed in this process are:
IPO Simulator Module
Announcement Effect or Event Effect Simulator
Portfolio Strategy Analysis Modules

Loans and bond evaluation, and yield estimation process: This process is composed of two elements: (1) mortgage, lease and loan analysis; and (2) bond analysis. Loans, leases and bonds share a common theme—they are fixed obligations of borrowers. While the first element reflects the viewpoint of a borrower, the second element reflects the viewpoint of an investor. Capital markets offers bond and mortgage backed securities which require an analysis from both points of view. For example, an investor in collateralized mortgage obligations needs to be aware of prepayment risk (payment of underlying mortgages during falling interest rate environment) and would wish to conduct mortgage and loan analysis as well as bond analysis. The two sets of tools complement each other, but may also be used independently. The bond evaluation and yield estimation process encompasses the following steps: (1) loan analysis based on prevailing interest rates to gauge the benefit of refinancing a mortgage or a loan at lower rates; (2) bond yield analysis to estimate the yield to maturity on an existing bond—including corporate bonds; (3) interpretations of yields for the investor's portfolio holdings and return objectives. The bond yield module also permits calculations of yields on callable bonds, which mimic prepayment on loans; as well as holding period yields for an investor for the purposes of projecting lifetime return on a bond investment. Forward rates, that are inseparably linked to yield to maturity on a treasury security and are referred to as term structure, can also be estimated, providing a glimpse of the market's consensus of the future course of interest rates, assisting an investor in bond risk management. Bond risk is linked to prepayment or reinvestment risk of interest payments as well as price risk for liquidation prior to maturity.

Leases and lending go hand in hand as both are fixed obligations. Leases are also securitized and sold to investors as investment vehicles. Knowledge of underlying lease rates, as imputed by lease terms, assists an investor in pricing such investments. The outlined process serves a dual purpose. It enables investors, who also simultaneously wear the consumer's hat, to be able to compare different financing options such as loans and leases for automobiles, capital goods with multi-year lives, and mortgage analysis by evaluating different loan alternatives side-by-side. The following modules are combined to implement the process described herein.
Loan Tool Module
Lease Rate and Payment Module
Bond Valuation Modules

Time value effect measurement process: Investors often invest in annuities and similar products offered by insurance companies and banks. Their payment stream is distributed across time at regular intervals time value effect measurement process enables investors to estimate the rate of return that can be earned by investing in an annuity. Conversely, an investor can estimate the minimum annuity payment that may be required for a desired return. The process requires estimation of annuity terms and their analysis with the help of the time value module. This module also enables analysis of payment streams other than annuities and spans a range of potential realistic scenarios. It is supplemented by an analysis of investment in a project or an opportunity that has uneven cash flows (even and regular cash flows define an annuity). Users can evaluate the attractiveness of investing in such opportunities with the help of discounting techniques. This approach can be used for real estate investing.

The process outlined herein relies upon the following steps: (1) estimation of annuity or single payment terms, and project (such as real estate) details; (2) configuration of the time value and net present value modules to drive desired analysis; and (3) make invest or reject decision on the basis of risk adjusted time value computations. The modules used in this process are:
Time Value of Money Module
Net Present Value Module

Stock portfolio management: The present inventive software provides a unique set of applications for identifying and managing an individual's portfolio. Their intent is to keep a user focused on long term investment goals minimizing impulsive or knee-jerk reactions to recommendations and random market movements. An investor can begin by identifying stocks based on chosen criteria with the help of the software's stock screener, followed by a detailed stock value analysis for attractiveness of stocks and their inclusion in the portfolio on the basis of their market prices vis-á-vis intrinsic or fundamental values. After cobbling together a tentative portfolio, the investor can test the performance of the portfolio using portfolio tools such as back test and life of portfolio analysis software. These procedures enable the user to gauge the endurance or consistency of a certain stock selection strategy, such as, high P-E ratio stocks, value stocks, large stocks, small stocks etc. After the sustainability and validity of an investing strategy has been tested and established the investor is able to asses the risk return tradeoff of the selected portfolio and compare it with other portfolios consisting of the same stocks but with different portfolio weights. The user can also benchmark the chosen portfolio against a market index for its efficiency and diversification benefits. As a final step, the user can estimate the probability of loss or gain from investing in the chosen portfolio over the investment horizon with the help of the probability estimator tool. This provides the user with an awareness of his or her loss tolerance ability. The user can repeat these steps beginning with the stock screener module to rebalance or alter the portfolio until a desirable risk return portfolio profile has been achieved. The software tools output the portfolio composition in terms of number of shares to be purchased for a given set of stock symbols in order to achieve the best portfolio, i.e., one that offers the highest risk (beta) adjusted return for a given risk level. The inventive software also provides specialized tools to identify special situations in the market for opportunistic investing with the help of its announcement and event-effect software tools. The IPO (initial public offerings) tool assists in assessing the past performance of IPOs that match a potential IPO of interest to an investor. In short, the philosophy or theme behind all the inventive software tools is “Test Before You Invest.”

A unique feature of all portfolio modules is that the user is always in the driver's seat. The user controls and specifies the estimation period as well as the method of analysis. In other words, the inventive software tools put the user in a financial analyst's chair, making the experience as interactive as feasible while being user friendly.

Risk management: The above portfolio management process is supplemented with a suite of option valuation, volatility and forward simulation tools to enable the user to mitigate or manage risk of a portfolio with derivative instruments should he or she choose to do so. A diverse set of models encompassing different exercise and dividend payment assumptions are provided to meet different stock and option characteristics. These option tools also serve to estimate the value of executive and employee incentive stock options, which are usually long term in nature and non-traded. The ability to value one's illiquid incentive stock options enables an individual to get a better picture of his or her total wealth than what would be available by only focusing on liquid stock market investments.

Fixed income investing: For investors who invest directly in bonds, the present invention has tools that make valuation of such instruments very easy and straightforward. These bond tools encompass valuation, holding period yields, yields to maturity/call/conversion as well as forward rates embedded in different bond maturity structures. These bond tools handle zero coupon bonds, coupon bonds, callable and convertible (into stock) bonds. The present inventive software offers analytical assistance in a myriad of investment situations.

Loan and leasing tools for everyday decisions: the loan and lease analysis tools provide solutions for everyday questions surrounding borrowing for a house, auto, college etc. Lease or purchase decisions are made easy with the graphical and tabulated output addressing, for example, lease versus purchase decisions and borrowing for 30 years versus 15 years to buy a house. Users can even analyze their credit card payments and the true cost of borrowing in the form of unsecured credit. In short, the inventive software tools have been designed by keeping an individual's financial and investment needs in mind.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

Accordingly, the present invention is not intended to be limited to the systems, structures, methods, and processes specifically described and illustrated herein. For example, the following description is particularly directed to a computer-implemented financial asset management system and method over an interactive communications network or computer network such as the Internet, but is not limited to such a communications network.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a general representation of the interaction between the user, the central processing unit (CPU) and memory bank of the computer, and their relationship to the output and its form for the time value of money module;

FIG. 2 is a illustrative screen of the input and output screen for the time value of money module, displaying the features of the module and the controls available to the user;

FIG. 3 is a general representation of the interaction between the user, the CPU and the memory bank of the computer, and their relationship to the output and its form for the loan comparison module;

FIG. 4 is an illustrative input screen for the loan evaluation module, displaying the entry fields and input choices available to the user;

FIG. 5 is an illustrative output screen for the loan evaluation module, displaying the results of loan comparative analysis as well as half-lives;

FIG. 6 is an illustrative output screen for the loan evaluation module, displaying the loan balance table in graphical form on each payment date, over a chronological calendar time line;

FIG. 7 is an illustrative output screen for the loan evaluation module, displaying the periodic payment along with its breakdown into interest and loan repayment components in graphical form on each payment date, over a chronological calendar time line;

FIG. 8 is an illustrative input and output screen for the calculation of the embedded lending rate for a given set of loan payment terms;

FIG. 9 is a general representation of the interaction between the user, the CPU and the memory bank of the computer, and their relationship to the output and its form for the lease rate calculation;

FIG. 10 is an illustrative input and output screen for the calculation of the embedded lease rate for a given lease commitment;

FIG. 11 is an illustrative input and output screen for the calculation of the embedded lease payment for a given lease commitment;

FIG. 12 is an illustrative output screen for the lease rate and payment module, displaying the lease balance table in graphical form on each payment date, over a chronological calendar time line;

FIG. 13 is an illustrative output screen for the lease rate and payment module, displaying the periodic lease payment along with its breakdown into interest and loan-equivalent principal repayment components in graphical form on each payment date, over a chronological calendar time line;

FIG. 14 is an embodiment of the process of information exchange between the user, the CPU, memory, database, live data feed and the processing algorithm for the stock valuation module;

FIG. 15 is an illustrative input screen for the statistical estimation of the required discount rate on a stock, which is the object of valuation in a series of sequential steps;

FIG. 16 is an illustrative input screen for the estimation of a stock's value under the constant growth assumption, along with controls and choices available to the user;

FIG. 17 is an illustrative output screen for the stock valuation module, displaying the estimated stock value in contrast with its 30-day moving average, along with projected dividends and terminal value of the stock at the end of the specified horizon;

FIG. 18 is a general representation of the interaction between the user, the CPU and the memory bank of the computer, and their relationship to the output and its form for the bond valuation module;

FIG. 19 is a flow chart for estimation of the yield on bond investment depicting the logic and sequence of the steps implemented in estimation based on an iterative search methodology;

FIG. 20 is an illustrative input screen for the estimation of a bond's value for different bond types, along with controls and choices available to the user;

FIG. 21 is an illustrative output screen for the bond valuation module, displaying the estimated bond value along with its graphical representation that includes a zero-coupon bond as well as a coupon bond's future cash flows along a chronological time line;

FIG. 22 is an illustrative input and output screens for the bond valuation module, displaying the estimated holding period yield for a bond investor in different bonds over a chosen time horizon, along with its graphical representation;

FIG. 23 is an extension of the output screens for the bond valuation module, displaying the estimated holding period yield for a bond investor in additional bond types over a specified time horizon;

FIG. 24 is an illustrative input and output screens for the bond valuation module, displaying the estimated forward rates derived from a series of bond structures specified in the data entry box;

FIG. 25 is an illustrative input and output screens for the bond valuation module, displaying the estimated yield curve derived from a series of bond structures specified in the data entry box;

FIG. 26 is a general representation of the interaction between the user, CPU, database and the memory bank of the computer, and their relationship to the output and its form for the portfolio strategy analysis module;

FIG. 27 is an illustrative first input screen for the portfolio strategy analysis module, displaying the portfolio creation and selection choices available to the user for the back-test analysis;

FIG. 28 is an illustrative second input screen for the portfolio strategy analysis module, displaying inputs needed to simulate back testing of a hypothetical or model portfolio created by the user;

FIG. 29 is an illustrative output screen for the portfolio strategy analysis module, displaying the performance results of the back testing of a hypothetical or model portfolio, along with its risk and comparison with an index portfolio of choice;

FIG. 30 is an illustrative first input screen for the portfolio strategy analysis module, displaying the portfolio creation and selection choices available to the user for life-of-portfolio analysis;

FIG. 31 is an illustrative second input screen for the portfolio strategy analysis module, displaying inputs needed to simulate life-of-portfolio testing of a hypothetical or model portfolio created by the user;

FIG. 32 is an illustrative output screen for the portfolio strategy analysis module, displaying the performance results of the life-of-portfolio testing of a hypothetical or model portfolio, along with its risk and comparison with an index portfolio of choice;

FIG. 33 is an embodiment of the exchange of inputs and information between the user, CPU, processing algorithm, memory and database for the risk and return tradeoff module;

FIG. 34 is a detailed representation of the process flow for the risk and return tradeoff module displaying statistical manipulation of historical data for creation of risk and return and parametrics, along with the tabulation and graphical production of results;

FIG. 35 is an illustrative graphical output of the simulated portfolios in a two-dimensional Cartesian space defined by risk and return measures of portfolio profile;

FIG. 36 is an illustrative graphical output of a simulated portfolio's risk decomposition according to individual security contributions to the magnitude of probable loss, in a pie-chart format;

FIG. 37 is an illustrative input screen for the risk and return tradeoff module, displaying inputs needed to simulate the risk profile of a hypothetical or model portfolio created by the user;

FIG. 38 is an illustrative output screen for the risk and return tradeoff module, displaying the risk parametrics of various portfolios contrasting their potential attractiveness for inclusion in an investment strategy, all measures being related to the risk profiles of four selected portfolios;

FIG. 39 is an illustrative output screen for the risk and return tradeoff module, displaying security compositions of four selected portfolios along with the graphical representations of their risk and return tradeoff measures, as well as risk decomposition along market and non-market factors;

FIG. 40 is an illustrative graphical output of a simulated portfolio's risk decomposition according to individual security contributions to the magnitude of probable loss, in a bar-chart format;

FIG. 41 is an embodiment of the exchange of inputs and information between the user, CPU, processing algorithm, memory and database, along with statistical manipulation for performance testing of a portfolio, for the IPO simulator module;

FIG. 42 is an illustrative first input screen for the IPO simulator module requiring portfolio selection or portfolio creation;

FIG. 43 is an illustrative second input screen for the creation of an IPO screening form for sample selection from a database of IPOs;

FIG. 44 is an illustrative third input screen for the specification of screening criteria for the selection of an IPO sample for performance analysis;

FIG. 45 is an illustrative final input screen for the specification of risk estimation methodology for analyzing the longitudinal and listing day performance of the selected IPO sample;

FIG. 46 is an illustrative tabular output of the performance of the IPO sample, represented under three different risk measurement methods;

FIG. 47 is an illustrative graphical output of the performance of the IPO sample under two risk measurement methods;

FIG. 48 is an illustrative graphical output of the performance of the IPO sample unadjusted for risk and in comparison with an index portfolio of choice;

FIG. 49 is an embodiment of the exchange of inputs and information between the user, CPU, processing algorithm, memory and database, along with statistical manipulation for performance testing of a portfolio, for the announcement effect module;

FIG. 50 is an illustrative first input screen for the announcement effect module requiring portfolio creation;

FIG. 51 is an illustrative second and final input screen for the specification of risk estimation methodology for analyzing the longitudinal and announcement day performance of the specified sample portfolio;

FIG. 52 is an illustrative tabular output of the performance of the announcement effect sample portfolio, represented under three different risk measurement methods;

FIG. 53 is an illustrative graphical output of the performance of the announcement effect sample under two risk measurement methods;

FIG. 54 is an illustrative graphical output of the performance of the announcement effect sample unadjusted for risk and in comparison with an index portfolio of choice;

FIG. 55 is an embodiment of the exchange of inputs and information between the user, CPU, processing algorithm, memory and database, along with statistical manipulation for performance testing of a portfolio, for the option valuation module;

FIG. 56 is a representation of data flow and sub-processes interacting to produce option values with the help of probability measures and volatility estimations;

FIG. 57 is an illustrative first input screen for the option valuation module requiring inputs for volatility estimation;

FIG. 58 is an illustrative first output screen for the option valuation module presenting stock return volatility estimates;

FIG. 59 is an illustrative second input screen for the option valuation module requiring inputs for option value estimation, with stock price and volatility filled in automatically;

FIG. 60 is an illustrative second output screen for the option valuation module presenting option value estimates along with option price sensitivities;

FIG. 61 is an illustrative final output screen for the option valuation module presenting an option value graph for a call option;

FIG. 62 is an illustrative final output screen for the option valuation module presenting an option value graph for a put option;

FIG. 63 is an illustrative input screen for the option valuation module requiring inputs for the binomial pricing model;

FIG. 64 is an illustrative output screen for the option valuation module under the binomial option assumption;

FIG. 65 is an embodiment of the exchange of inputs and information between the user, CPU, processing algorithm, memory and database, along with statistical manipulation for estimation of volatility under the implied option volatility module;

FIG. 66 is an illustrative input screen for the option volatility module requiring inputs for estimation of volatility of an option whose price is known;

FIG. 67 is an illustrative output screen for the option volatility module under the different exercise conditions;

FIG. 68 is a representation of instruction flow for projection of option values at a future date under a simulation experiment for the forward option value simulation with probabilities;

FIG. 69 is an illustrative first input screen for the option simulation module requiring inputs for option value estimation;

FIG. 70 is an illustrative second input screen for the option simulation module requiring user inputs;

FIG. 71 is an illustrative first output screen for the option simulation module presenting projected call option values at the specified future date and their likelihood estimates;

FIG. 72 is an illustrative input and output screen for the option simulation module presenting the user an input form for a probability estimate of a specified range of future option values;

FIG. 73 is an illustrative output screen for the option simulation module presenting projected stock price values at the specified future date and their likelihood estimates;

FIG. 74 is an illustrative first output screen for the option simulation module presenting projected put option values at the specified future date and their likelihood estimates;

FIG. 75 is an illustrative input screen for the gain/loss probability estimator module;

FIG. 76 is an illustrative output screen for the gain/loss probability estimator module presenting estimated probability for the range of loss or gain specified;

FIG. 77 is an embodiment of the computer data flow between the user, memory, CPU and the controlling algorithm for the presentation of the output to the user;

FIG. 78 is an illustrative input screen for the net present value module;

FIG. 79 is an illustrative output screen for the net present value module presenting a graphical output to the user;

FIG. 80 is the overall investment management process for the portfolio creation, validation, efficiency and loss tolerance determination;

FIG. 81 is the detailed process diagram setting out the logic and the feedback loop of the investment management process for the portfolio creation, validation, efficiency and loss tolerance determination.

### DETAILED DESCRIPTION OF THE INVENTION

Computer System Environment of the Present Invention

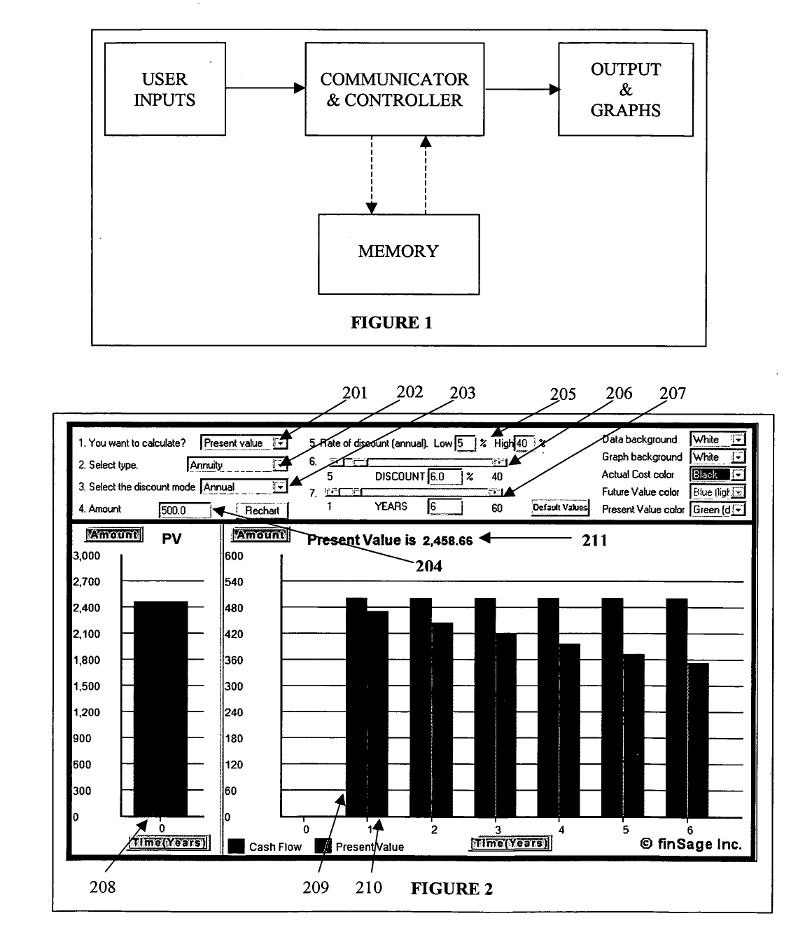

With reference now to FIG. 1, portions of the present system and computer-implemented method are comprised of computer-readable and computer-executable instructions which reside, for example, in computer-usable media of a computer system. FIG. 1 illustrates exemplary computer systems used as a part of the financial asset management system in accordance with the present invention. It is appreciated that the system as illustrated in FIG. 1 is exemplary only and that the present invention can operate within a number of different computer systems including general purpose computers systems, embedded computer systems, and stand alone computer systems specially adapted for automatic system error analysis. A computer-usable medium may include any kind of computer memory such as floppy disks, conventional hard disks, CD-ROMS, Flash ROMS, nonvolatile ROM, and RAM. Preferably, the system is implemented over a network such as an intranet or the Internet. The software may be distributed on various servers to load-balance application processes.

The present inventive system is preferably implemented via the Internet. The Internet is a collection of computers, computer networks, mobile computers, and other web-enabled devices capable of communicating with one another through different electronic services. As a composite entity, the Internet is sometimes referred to as “The web”. The most common services available on the Internet are electronic mail (email) and the World Wide Web (WWW).

The WWW service on the Internet permits users to send and receive the contents of web pages. Web pages are the basic method through which information is made available to the heterogeneous computer systems connected to the Internet. Web pages are electronic documents that are displayed and distributed by a computer program called a web server. The web server is the program responsible for sending web pages to other computer systems in response to specific electronic requests issued by these computer systems and placed on the Internet. Web pages can contain a variety of content including graphical images, audio files, video files, streaming audio, streaming video, text, and other forms of information including small computer programs called applets.

Database Environment of the Present Invention

A database management system, commonly referred to herein as a database, is used in conjunction with the present invention for the storage and retrieval of various information captured by system interfaces, such as a user interface, or information that is manipulated by program logic. Preferably, the database is of the relationship type, although other hierarchical, n-tier or other database capable of storing and retrieving the information used by the system may be utilized.

A relational type of database is commonly made up of tables containing records. The fields may be of various data types and lengths. A record usually consists of one or more fields. Another name for a record is a row. A collection of records are referred to as sets. Tables often have fields that serve as key values that make a record unique in a table. Also, two or more tables may be joined together through the use of an intersection table or through programmatic code that will join table together based on field values.

The database used with the inventive system may reside on a single database server, or may be distributed on multiple database servers. For example, a database may be configured in such a way that the computer files that contain the data of the database, may reside on separate computer servers. Also, database data may reside logically in memory such as RAM.

Also, the database of the inventive system may be accessed from user interfaces of the present invention, either directly or indirectly (for example, through an intermediary application program), or a combination thereof. User interfaces may contain programming code that allows the user interface to directly access the database management system. Alternatively, the programming logic may interact through one or more intermediary programs which receives storage and retrieval requests. The intermediary program may handle the direct interaction to the database.

The present invention preferably includes a database with a database structure configured for the collection of financial asset data, such as stocks and bonds. Additionally, other data structures may include administrative tables, and the like. There are three individual databases storing information both for the simulators and the results of those simulators.

The largest of the three databases contains information about 23,000+ stock tickers and 5 indexes including the open, high, low, close and volume of the stock for every trading date starting with Jan. 1, 1993. This data is used to calculate information (i.e. Beta, Volatility, etc) for a stock or index for use in calculations. This database also includes tables for IPO information, SIC Codes, and (Yields).

A second database stores information for tools such as the:
Portfolio Manager (User defined name, creation date, tickers held and transactions).
Portfolio Simulations (User defined name, portfolio date, value and test results).
Announcement Effect modules (User defined name, type, tickers held, date of announcement and test results).

Information in these tables are generally entered by the user through a front end on the web site and used to track portfolios and run simulations on “model portfolios”. This database also includes the information to display the details of Index.

The third database stores results of certain tests (Holding Period Returns, Advance Options Simulations, etc.) both for graphic purposes and to allow users to store their results.

These three databases do not store personally identifying information for any user, nor do they contain credit card or other account information.

Software Modules of the Present Invention

The present invention includes a number of various modules that may act together, or independently of one another. Some of the modules include sub-modules. The main modules are as follows:
Module 1. Time Value of Money
Module 2. Loan Tool
Module 3. Lease Rate and Payment Tool
Module 4. Stock Valuation Modules
Module 5. Bond Valuation Modules
Module 6. Portfolio Strategy Analysis Modules
Module 7. Portfolio Risk Return Tradeoff
Module 8. IPO Simulator Module
Module 9. Announcement Effect or Event Effect Simulator
Module 10. Option Valuation Module
Module 11. Option Volatility
Module 12. Forward Option Value Simulation with Probabilities
Module 13. Gain/Loss Probability Estimator
Module 14. Net Present Value Module
Module 15. Investment Process for Portfolio Creation, Validation, Efficiency and Loss Tolerance Determination

These modules are further described below.

Module 1. Time Value of Money Module

The Time Value of Money Module allows the user to make present and future value computations for single payments, annuities, annuities due, and unequal payments stretching over many periods easy and fast. This tool can be used to analyze insurance products that have features described above.

This simulator is very advanced and is accompanied by graphs (refer to FIG. 2). The graphs break down calculations into pictorial representations for maximum understanding. Users can change inputs (such as, interest rate, payment amount, time period) by moving a slider bar and visually see the present and future value graphs update in real time as they are changing the inputs on a slider control. The module performs repeated calculations as inputs are changed and shows how changing a certain input affects the results. The module computes:
Future Value of a Single Sum
Present Value of a Single Sum
Future Value of an Ordinary Annuity
Present Value of an Ordinary Annuity
Future Value of an Annuity Due
Present Value of an Annuity Due
Future Value of Unequal Payments over Time
Present Value of Unequal Payments over Time

The software takes user inputs and discounts or compounds cash flows to arrive at present and future values and their graphical representations. The following formulas are used to compute present and future values:
Future value (FV), at time T, of a single sum (PV)
   FV_{T}=PV(1+k)^{T}
Present value (PV) of a single sum, CFT, received at time T
   PV=CF_{T}/(1+k)^{T}
Future value, at time T, of an ordinary annuity lasting T periods paying CF per period
   FVA_{T}=Σ_{t=1 to T} CF(1+k)^{T-t}
Present value of an ordinary annuity lasting T periods paying CF per period
   PVA=Σ_{t=1 to T} CF(1+k)^{t}
Future value, at time T, of an annuity due lasting T periods
   FVAD_{T}=FVA_{T}(1+k)
Present value, at time T, of an annuity due lasting T periods
   PVAD=PVA(1+k)
   All payments are assumed to be at equal intervals.
Future value, at time T, of unequal payments over time lasting T periods paying CFₜ per period
   FVU_{T}=Σ_{t=1 to T} CFₜ(1+k)^{T-t}
Present value of unequal payments over time lasting T periods paying CFₜ per period
   PVU=Σ_{t=1 to T} CFₜ/(1+k)^{t}
   k is the one-period discount rate.

Once results have been presented to the user, the user can vary inputs by moving a control button (refer to FIG. 2) along a slider bar (206 & 207). As the user moves the control button to change the input, the software responds in a super-fast manner to vary the numerical and graphical results (208, 209 & 210) in real time. When the output reacts to user action instantaneously and dynamically, with no or imperceptibly small delay, the user experiences a feeling of control and instant visualization for a better understanding of cause and effect relationships, which is essential in investment management.

In this module, the user selects/provides the following inputs (refer to FIG. 2)
Present value or future value (201)
Single payment, annuity, annuity due, unequal payments or perpetuity (202)
Discount rate—annual, semi-annual, quarterly, or monthly (203)
Enter amount (204)
Specify range of low and high values for discount rate (205)
Select a discount rate between the specified rate on a slider bar/enter information in a text box (206)
Select the period or number of year on a slider bar/enter information in a text box (207)

The user observes the following results/output (refer to FIG. 2)
Present or future value as specified by the user (211)
Graph of present or future value (208)
Graph of present or future value of every future payment along with undiscounted/uncompounded value (209 & 210)
The user is able to change inputs by moving slider bars and can see the effect immediately on output in real time as the graph updates dynamically (206 & 207)

Module 2. Loan Tool Module

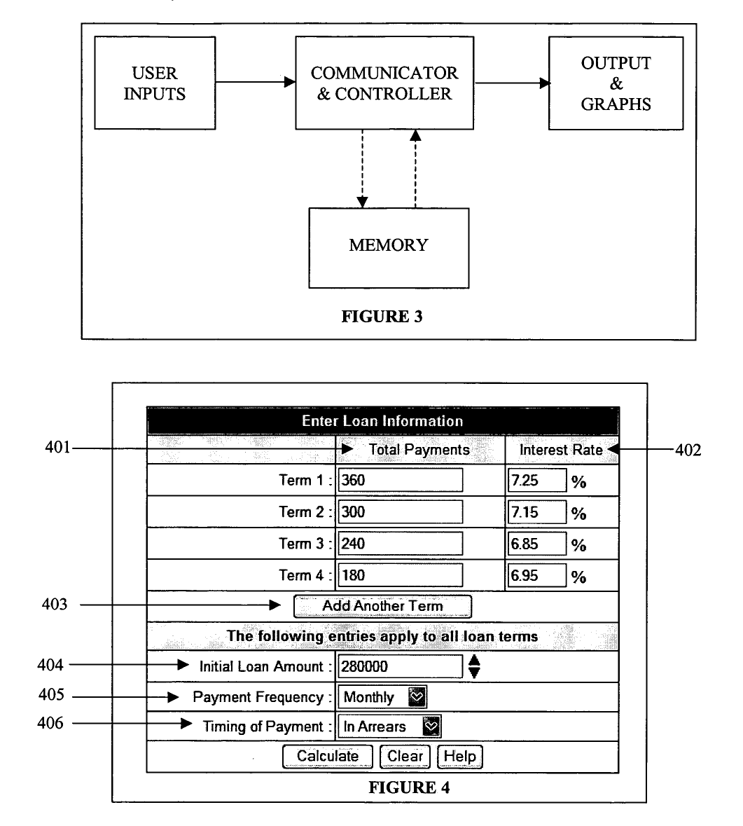

The Loan Tool module (refer to FIG. 3) makes comparison of different loans and their terms possible at a glance. The loan module presents the output for several loans being compared. In addition to payment details, it also presents half-lives for payment and outstanding balance. Half-lives represent the time it takes to reach a point when at least half of the payment is applied to loan repayment, or, the outstanding balance reaches half its original value. The graphical output shows each payment and its breakdown into interest and principal components, both graphical. The graphical output also shows outstanding loan balance after each payment.

User inputs are processed by the software module with the help of discounting formulas. These are provided below:
Payment=Principal/[(1−1/(1+k)^{N})/k]
Where k is the periodic interest rate on the loan and N is the number of payments remaining.
Interest component=Principal×k
Principal repayment=Payment−Interest component

Half-life of the outstanding balance is the time it would take to reduce the principal by at least half. Half-life of the payment is the time it would take to apply at least half the payment to the principal.

Inputs are transformed into payment details of interest and principal repayment. Results are also displayed graphically. The output also displays the half-life of payment and outstanding loan amount, a computation that is not seen elsewhere in loan analysis tools. The concept of half-life is borrowed from science and pertains to the half-life of an element associated with its decay.

The tool also enables a user to infer the lending rate on a loan if payment, term, frequency and loan amount are specified. The following equation is solved iteratively for k.
Payment=Principal/[(1−1/(1+k)^{N})/k]

In this module, the user selects/provides the following inputs:

Step 1: The user selects/provides the following inputs (refer to FIG. 4)
Loan terms (401)
Interest rate for different loans (402)
Amount borrowed (404)
Payment frequency—monthly. weekly, or annual (405)
Timing of payment (arrears or advance) (406)

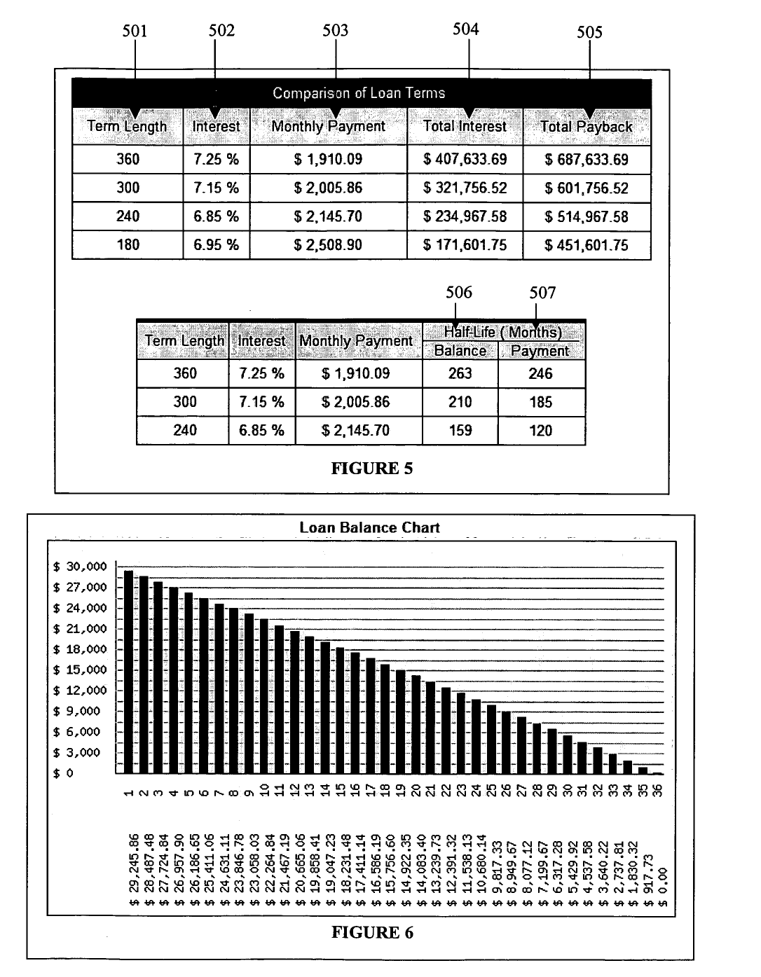

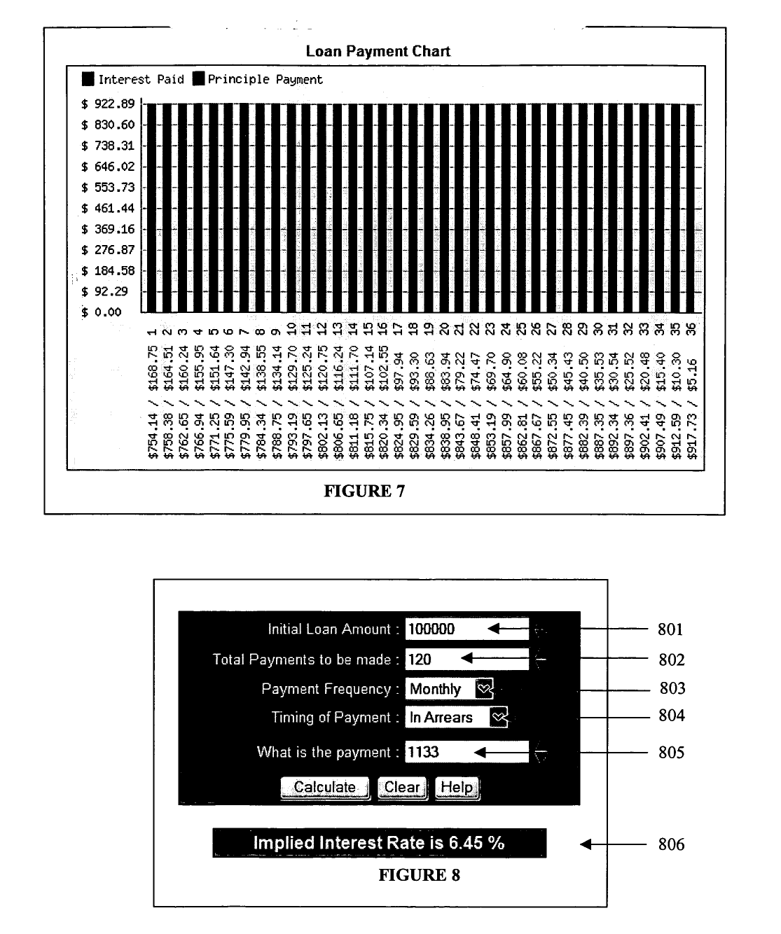

Step 2: The user observes the following results/output (refer to FIGS. 5 & 6)
Tabular output laying out:
   monthly payment for each loan (503)
   total interest payment over life of loan for each loan (504)
   total payback for each loan (505)
   half-life of loan balance—number of payments required to reach the point when the outstanding loan balance reaches half its original value (506)
   half-life of periodic payment—number of payments required to reach the point when half the payment is applied to balance reduction (507)
Graphic displays (bar chart) showing, for each loan:
   outstanding loan balance and its value after each payment (refer to FIG. 6)
   each payment—its value, and breakdown into principal repayment and interest components (refer to FIG. 7)

Step 3: The user provides the following inputs to infer the lending rate (refer to FIG. 8)
Initial loan amount (801)
Total payments to be made (802)
Payment frequency—monthly, weekly, or annual (803)
Timing of payment (arrears or advance) (804)
Payment amount (805)

Step 4: The user observes the following output/result (refer to FIG. 8)
Implied interest rate on the loan (806)

Module 3. Lease Rate and Payment Tool Module

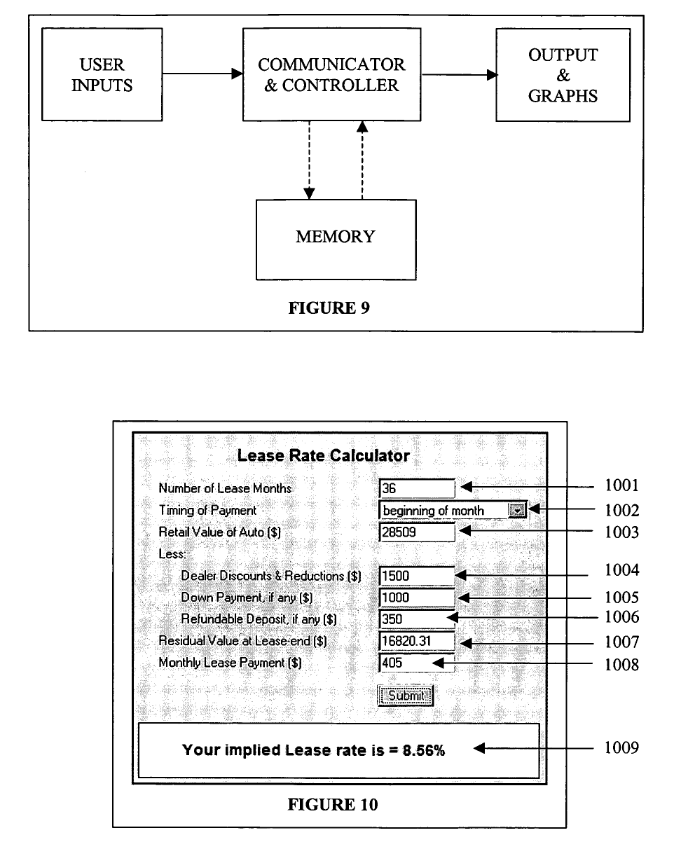

The lease rate module (refer to FIG. 9) computes the implied rate on which lease payments are based given the initial value and residual value of the asset being financed under a lease. The lease rate can be compared with the rate on a loan if the user wants buy an asset instead of leasing it.

This module uses numerical techniques to compute the interest rate assumed for a lease. For example, for an auto lease, it computes the lease rate after the user specifies the retail value of the auto, dealer discounts and reductions, down payment, trade-in value, lease deposit, and residual value. Resulting lease rate can be compared with the rate on a loan for a buy or lease decision.

The lease rate software module accepts user inputs and employs a numerical search technique to reverse engineer the lease rate. The method iteratively seeks the steepest descent or ascent gradient to zero-in on the target lease rate within a specified tolerance range. The lease payment tool uses the specified lease rate to compute the lease payment. The two software tools can be thought of as exact opposites of each other. The output of the lease payment tool includes a split of the lease payment into interest and lease balance components. This lease payment split is not seen elsewhere in similar financial modules. Lease balances after every payment are also reported to the user. This enables the user to view a lease in its proper light, as an alternative to loan financing with very similar (fixed) obligations. The following equation is used for computing results:
Lease payment=[Asset (Loan) value−Residual value]/[(1−1/(1+k)^{N})/k]+Residual value×k
Where k is the periodic lease rate. It is solved iteratively. If k is specified, lease payment is computed and presented to the user. Asset value is adjusted for discounts and reductions as well as any down payment and deposit; the residual value is adjusted for the deposit.

Step 1: The user selects/provides the following inputs for lease rate calculation (refer to FIG. 10)
Number of lease months (1001)
Timing of payment (beginning or end of month) (1002)
Retail value of asset (1003)
Discounts and reductions offered by seller (1004)
Down payment by lessee (1005)
Refundable deposit required by lessor (1006)
Lease-end residual value of asset offered by lessor (1007)
Lease payment required by financing company (lessor) (1008)

Step 2: The user observes the following output/results (refer to FIG. 10)
Implied lease rate (1009)

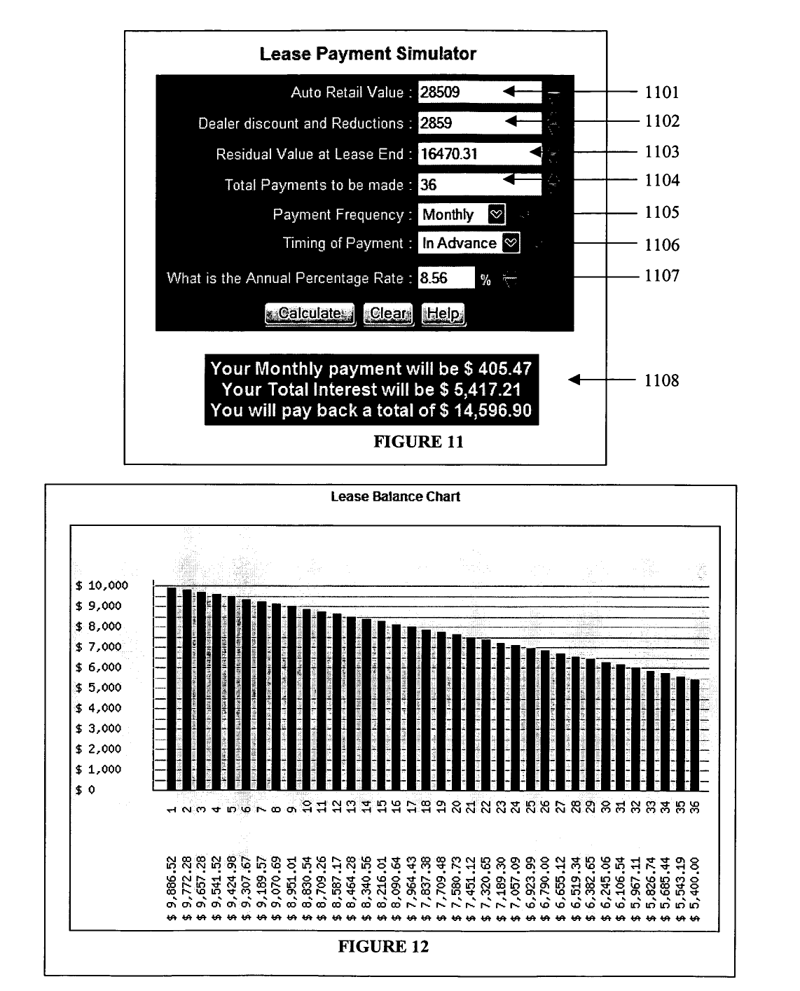

Step 3: The user selects/provides the following inputs for lease payment calculation (refer to FIG. 11)
Asset retail value (1101)
Discounts & reductions (1102)
Lease-end residual value (1103)
Total payments required to be made (1104)
Payment frequency—monthly, weekly or annual (1105)
Timing of payment—in advance or an the end of period (1106)
Lease annual percentage rate (APR) (1107)

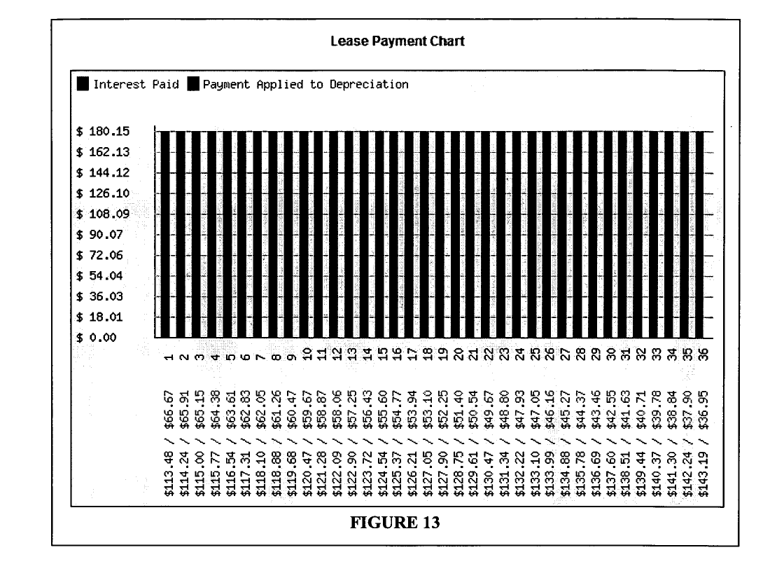

Step 4: The user observes the following results/output (refer to FIGS. 11, 12 & 13)
Periodic lease payment (1108)
Total interest over term of lease (1108)
Total payback to the lessor (1108)
Graphical reporting of outstanding lease balance after each payment (refer to FIG. 12)
Graphical reporting and lease payment breakdown into two components: interest and lease balance reduction (refer to FIG. 13)

Module 4. Stock Valuation Modules

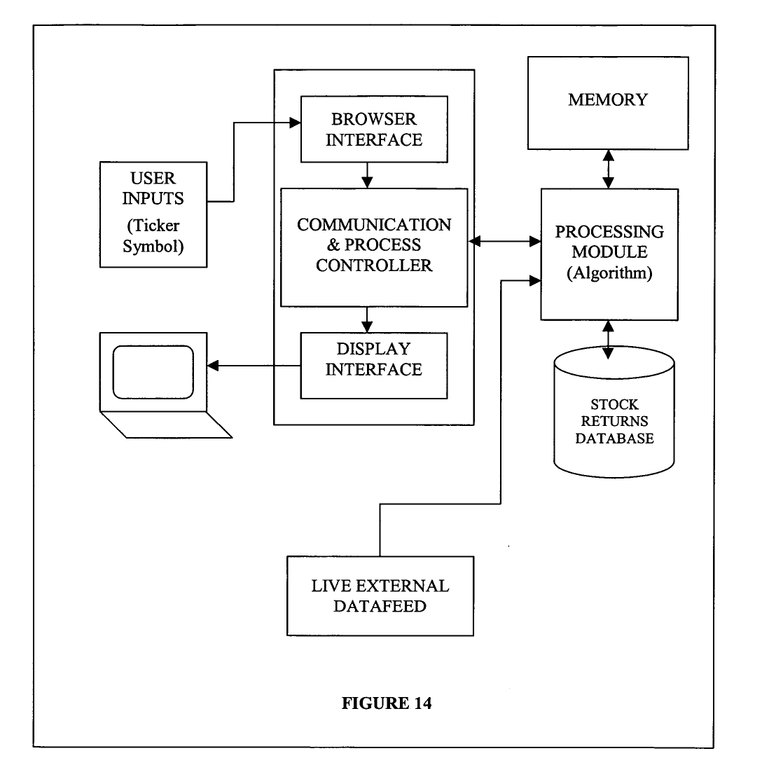

The stock valuation modules (refer to FIG. 14) enable a user to value a stock based on projected dividends, rate of dividend growth and risk of the stock.

In this module, the user enters a ticker symbol and the module computes the beta risk, and a discount rate based on beta risk and the risk free rate, which is available from the a database. The module fills in the last dividend paid by the company as well as the discount rate computed into the model, requiring the user to provide the estimate of growth rate(s) or future dividends depending on the module. The output includes the current estimated stock value based on inputs provided as well as a graphical representation that includes projected stock value at the end of a terminal period. The user is able to select the period of beta-risk calculation from a set of choices. Modules included:
Constant Growth Simulator
Supergrowth (2-stage) Stock Simulator
Unequal Dividends Stock Simulator
Gain/loss Probability Estimator

The Gain/Loss Probability Estimator is integrated into each of the other three tools for estimation of loss tolerance by an investor. The Constant Growth and Supergrowth simulators supplement Unequal Dividends simulator for terminal value computation.

These integrated modules accept the user specified ticker symbol and the beta estimation period and reaches into the a historical stock price database. After extracting returns for the index and the ticker for the specified period, they econometrically compute the beta of the stock. They combine the computed beta with the risk free rate (T-Notes) stored in the (T-Notes) stored in the a database and produce a discount rate for the ticker. The modules automatically fill in the most recent dividend paid by the stock. Dividend is extracted from a live stock data feed. After the user provides the growth rate(s) or dividends the modules estimate the current value of the stock. They also project a future value for the stock at the end of the specified charting period and display the results in a tabulated as well as graphical format. The stock value is computed as:
Constant growth:
   Value=[Dₗₐₛₜ×(1+growth rate)]/(Discount rate−growth rate)
Supergrowth:
   Value=[Σ_{t=1 to T} Dₜ/(1+k)^{t}]+(1/(1+k)^{T})×[D_{T+1}/(k−g)]
Unequal dividends:
   Value=[Σ_{t=1 to T} Dₜ/(1+k)^{t}]+[(1/(1+k)^{T})×P_{T+1}
   Where Dₜ is the dividend at time t, k is the discount rate, g is the constant long-term growth rate, T is the end of the supergrowth period or time horizon under unequal dividends, and P_{T+1} is the projected price at T+1.

The user can then query the module to estimate the chance of gaining or losing a specified amount from an in investment in the chosen stock over a specified period in the future. The modules compute stock volatility and use the beta-risk driven projected discount rate to estimate the chance of gain or loss using a normal (random) distribution. The modules essentially combine several operations and integrate sub-processes into a super-process involving several database operations, mathematical calculations, statistical and econometric computations, times series data manipulation as well as incorporating of random distributions. Normal distribution is just a special case. The modules can handle several different (twenty or more) distribution types.

(a) Stock Analysis Modules

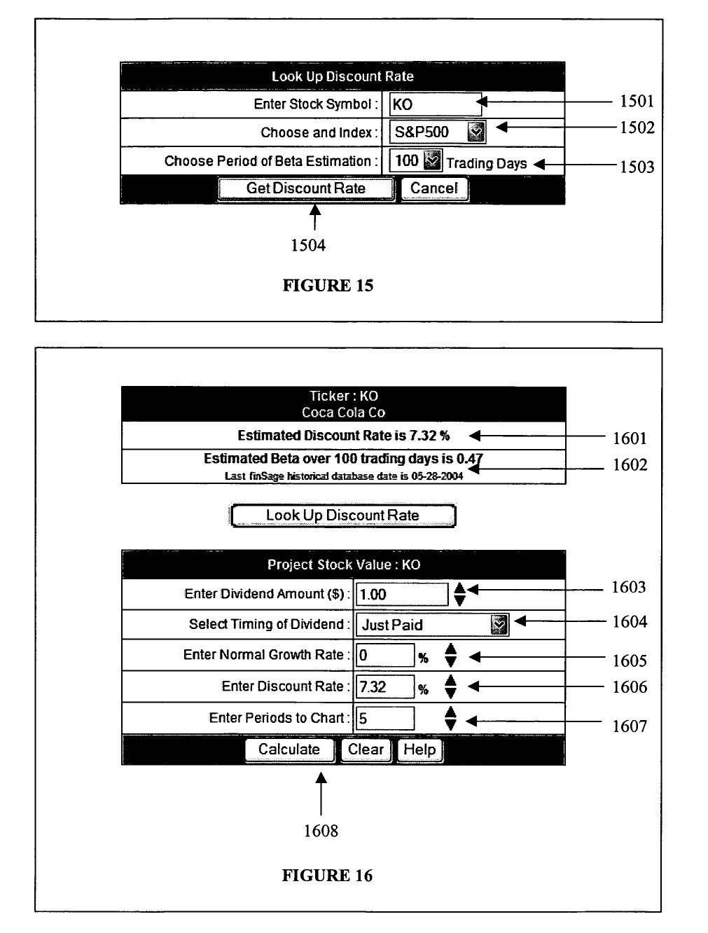

Step 1: The user selects/provides the following inputs (refer to FIG. 15)
Enter stock ticker symbol (1501)
Select a market index (1502)
Choose period of beta risk estimation (1503)
Click on “Get Discount Rate” button (1504)

Step 2: The user observes the following intermediate results/output (refer to FIG. 16)
The module presents the estimated discount rate (1601)
The module presents the stock's beta risk (1602)
The module fills in last dividend paid by the company (1603)
The module fills in the estimated discount rate (1606)
The module defaults to 5 years of charting (1607)

Step 3: The user selects/provides the following inputs (refer to FIG. 16)
Enter dividend amount or accept default (1603) Enter timing of dividend payment or accept default (1604)
Enter future dividend growth rate(s) depending upon the module being used (1605)
Accept default discount rate or enter new (1606)
Enter number of future periods to chart or accept default (1607)
Enter terminal value computed on the basis of constant growth or supergrowth model, at the end of the terminal period for unequal dividends model (unequal dividends module)
Click on calculate button for result (1608)

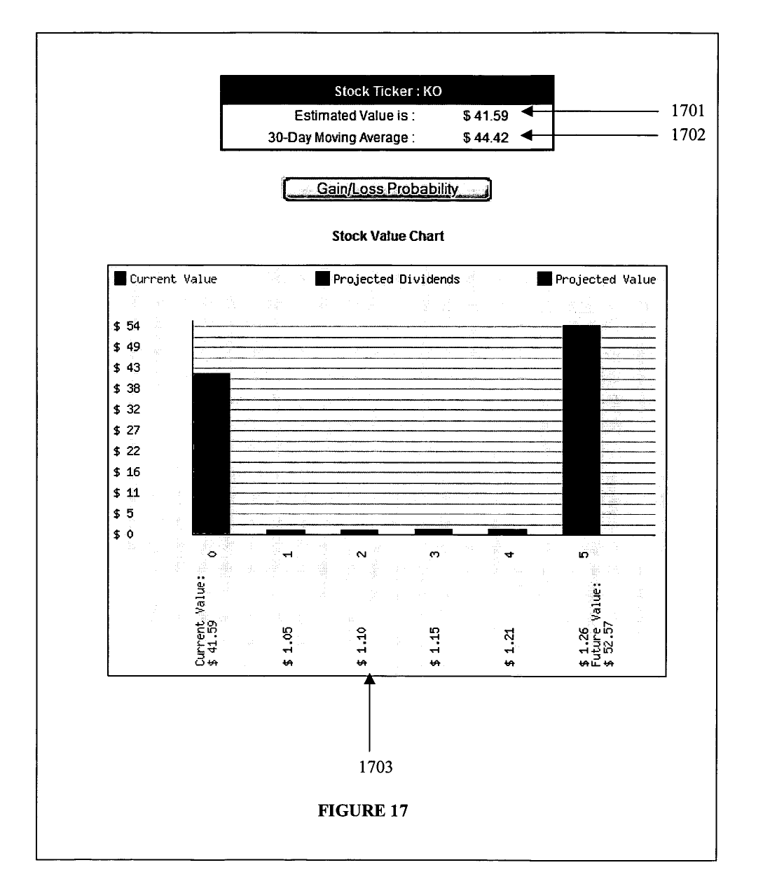

Step 4: The user observes the following results/output (refer to FIG. 17)
Tabular output consists of:
   Estimated current stock value on the basis of inputs provided (1701)
   30-trading day average price for the stock from historical data (1702)
Graphical output consists of estimated current stock value, projected future dividends, and future stock value (1703)
   Estimated current stock value
   Projected future dividends
   Projected stock value at the end of the specified charting period

(b) Gain/Loss Probability Estimator (See Module 13 for More Details)

The user selects/provides the following inputs:
Choose gain or loss specification from a dropdown list box
Specify the gain or loss amount
Accept the default projected portfolio annual return calculated on the basis of beta risk from part (a) above, or override the same
Accept the default portfolio volatility calculated in part (a) above, or override the same
Specify the period over which the chance or probability of gain or loss is to be estimated
Click on the submit button

The user observes the following results/output:
The module fills in the value of the portfolio
The numerical output returns the chance or probability of losing or gaining the specified amount over the specified period.
The first graphical output shows the breakdown of the total gain or loss by the ticker symbol, giving the user an idea of how much each stock contributes to potential gain or loss in a sideways bar chart
The second graphical output presents the information in a pie chart format for an alternative visualization of loss or gain by ticker

Module 5. Bond Valuation Modules

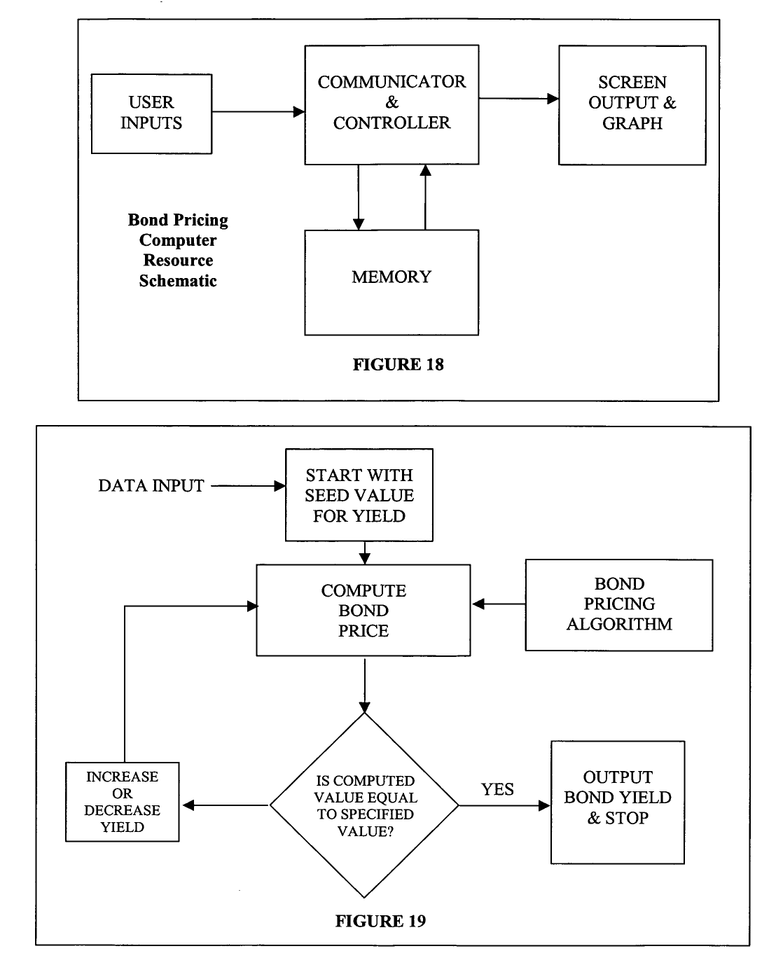

The Bond Valuation Modules provide for valuation of different types of bond investments (refer to FIG. 18).

The pricing component of the bond value module computes the value of bonds based on inputs selected by the user and presents a graphical output showing future coupon payments and cash flows. The user is able to vary inputs and instantaneously see the effect on the results. The user can also infer a series of future interest rates (forward rates) as well as the yield curve computed from different bond structures entered into the model. The user is also able to compute the holding period yield (refer to FIG. 19) for a multi-period investment or bond holding period. The module computes the following bond related parameters:
Bond price
Bond yield to maturity
Bond holding period yield
Bond forward rates
Bond yield curve

User inputs are processed by this software module with the help of discounting formulas. Inputs are transformed into theoretical bond prices, or, embedded yields if bond prices are given and the user is solving for yields or rates of return.

The following formulas are used for bond pricing and yields:
(a) Zero-coupon bond
   Price=M/(1+Y)^{T}
where M is the maturity principal, Y is the discount rate, and T is the number of periods remaining.
(b) Coupon bond
   Price=[Σ_{t=1 to T} C/(1+Y)^{t}]+[M/(1+Y)^{T]}
where M is the maturity principal, C is the coupon payment, Y is the discount rate, and T is the number of periods remaining until maturity.
(c) Callable bond
   Price=[Σ_{t=1 to T}_{_{C}} C/(1+Y_{C})^{t}]+[P_{C}/(1+Y_{C})^{T}^{_{C}}]
where P_{C} is the call price, Y_{C} is the discount rate, and T_{C} is the number of periods remaining until expected call. Other symbols have the same meaning as before.
(d) Convertible bond
   Price=[Σ_{t=1 to T}^{_{C}} C/(1+Y_{Cv})^{t}]+[V_{Cv}/(1+Y_{Cv})^{T}^{_{Cv}}]
   Conversion value=V_{Cv}=Conversion value×(M/Conversion ratio).
Where V_{Cv} is the conversion value, Y_{Cv} is the discount rate, and T_{Cv} is the number of periods remaining until expected conversion. Other symbols have the same meaning as before.

Yields Y, Y_{C}, or Y_{Cv}, are calculated iteratively using the same formulas starting with a seed value (refer to FIG. 19). If the user specifies a reinvestment the same is handled in the above equations.

Forward rates are computed on the basis of the following equation, applied reiteratively:
M/(1+Y)^{τ}=M×π_{t=1 to τ-1} [1/(1+ₜƒₜ₊₁)]; τ=1, 2, . . . T

Yield curve is estimated on the basis of zero-coupon bonds, using the following equation:
Price_{τ}=M/(1+Y_{τ})^{τ}; τ=1, 2, . . . T

Results are also displayed graphically. For the yield component, the solution is based on numerical techniques that iteratively seek the steepest descent or ascent gradient to zero-in on the yield to call/maturity/conversion or the holding period yield within a specified tolerance range. The module combines numerical output with graphical charts for easy and visual understanding of results.

(a) Bond Price Module

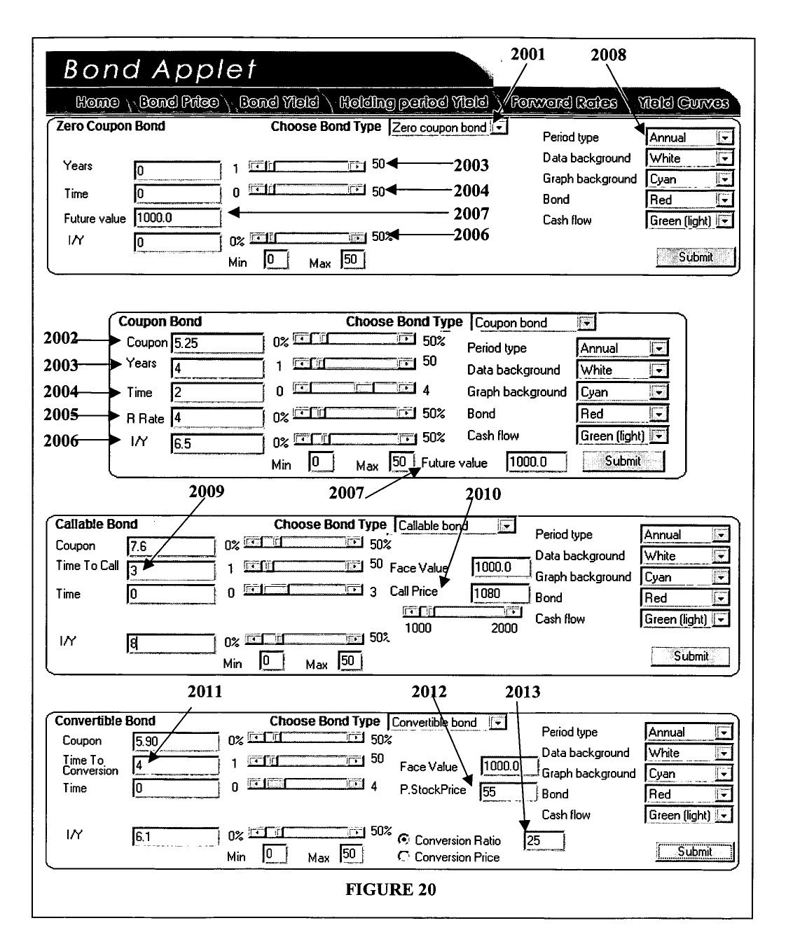

Step 1: In this module, the user selects/provides the following inputs (refer to FIG. 20)
Bond type—zero coupon, coupon, callable or convertible bond (2001)
Coupon rate (2002)
Term to maturity in years (2003)
Valuation date (time) (2004)
Future or maturity value of the bond (2007)
Reinvestment rate (2005)
Market yield or interest rate (2006)
Period type—annual or semi-annual (2008)
Time to call (2009)
Call price (2010)
Time to conversion (2011).
Projected stock price—used for conversion value (2012)
Conversion ratio (2013)

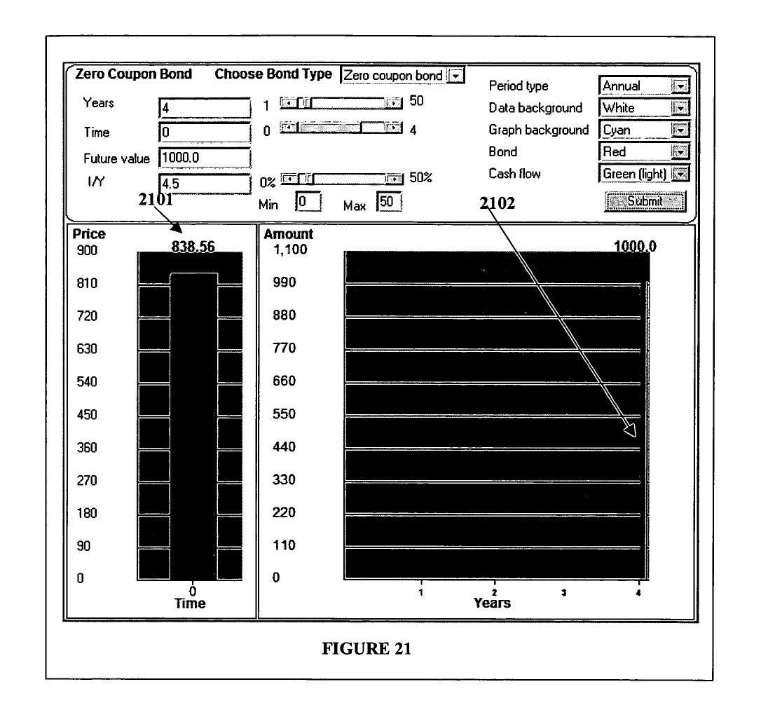

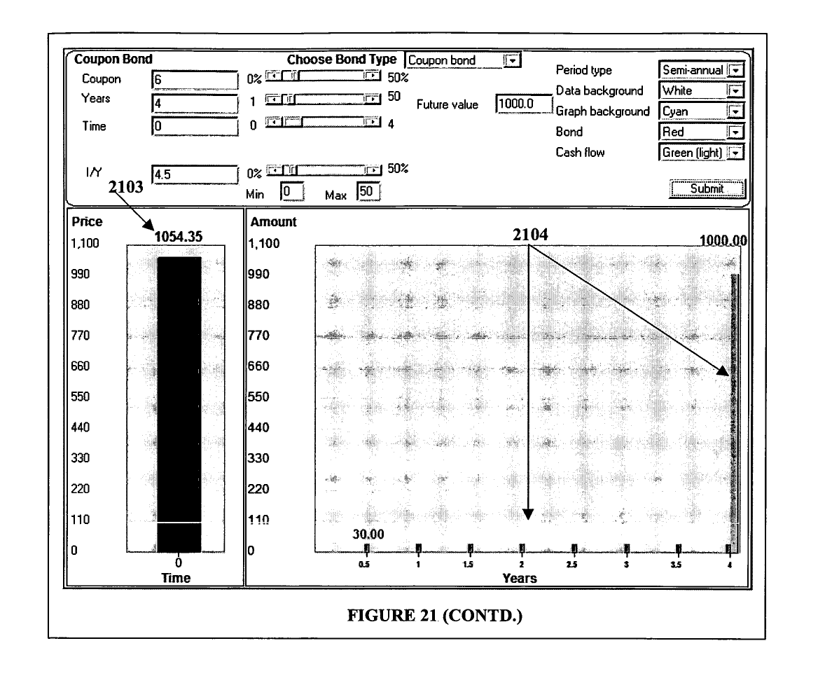

Step 2: The user observes the following results/output (refer to FIG. 21)
Calculated bond value (2101& 2103) Graphical output presents:
bond value calculated (2101 & 2103)
future coupon payments and maturity value on a time line (2102 & 2104)
the user is able to change inputs by moving slider bars and can see the effect immediately on output in real time as the graph updates dynamically

(b) Bond Yield Module

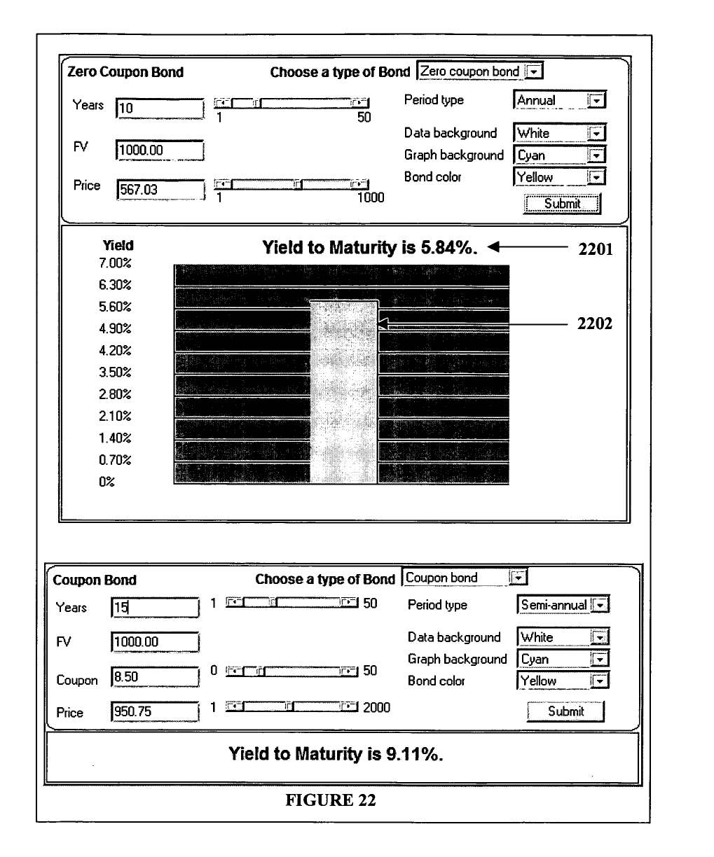

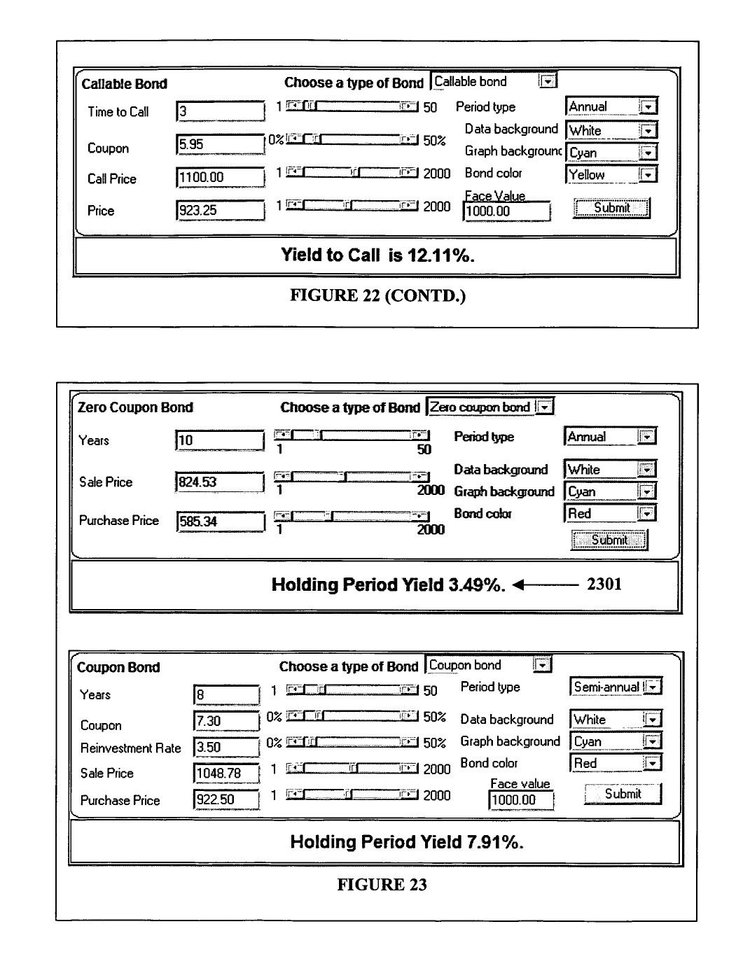

Step 1: The user selects/provides the following inputs (refer to FIG. 22)

The user enters the same information as listed under (a) Bond Price.

Step 2: The user observes the following results/output (refer to FIG. 22)
Calculated bond yield (2201)
Graphical output presents
   bond yield (yield to maturity, yield to call, yield to conversion) (2202)
   the user is able to change inputs by moving slider bars and can see the effect immediately on output in real time as the graph updates dynamically

(c) Holding Period Yield Module

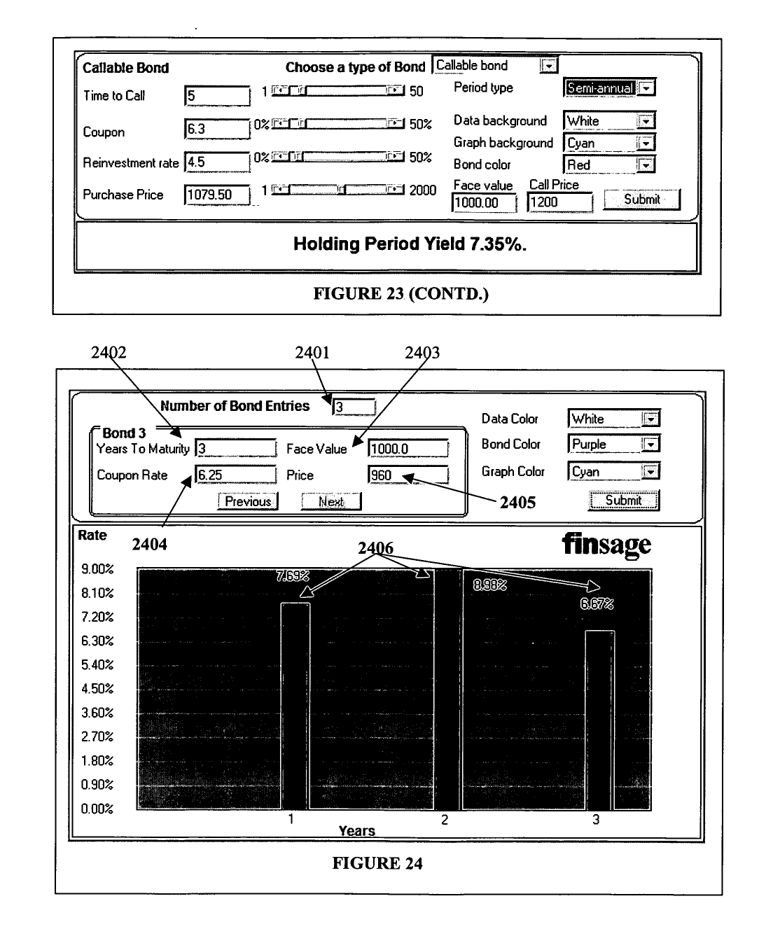

In this module (refer to FIG. 23), the user enters the same information as listed above under (a) Bond Price. Purchase price is entered as the bond price and sale price is entered as the future value. Formulas used are same as those given above. Specifically, the user selects/provides the following inputs:
Bond type—zero coupon, coupon, callable or convertible bond
Term to maturity in years
Purchase price
Sale price for zero or coupon bond
Future or maturity value of the bond
Call price or conversion price/conversion ratio and projected stock price
Annual coupon or interest percentage
Coupon type—annual or semiannual coupon
Reinvestment rate
Click on the submit button

The user observes the following results/output (refer to FIG. 23) Calculated holding period yield for different types of bonds (2301)
Graphical output presents the yield calculated above (omitted to avoid repetition)
The user is able to change inputs by moving slider bars and can see the effect immediately on output in real time as the graph dynamically updates in real time

(d) Forward Rates Module

In this module, the user selects/provides the following inputs (refer to FIG. 24)
Number of bond entries (2401)
For each bond structure:
   years to maturity (2402)
   coupon rate (2404)
   face value (2403)
   current price (2405)

The user observes the following results/output (refer to FIG. 24)
Calculated forward rates for different future periods (2406)
Graphical output presents the calculated rates (2406)

(e) Yield Curve Module

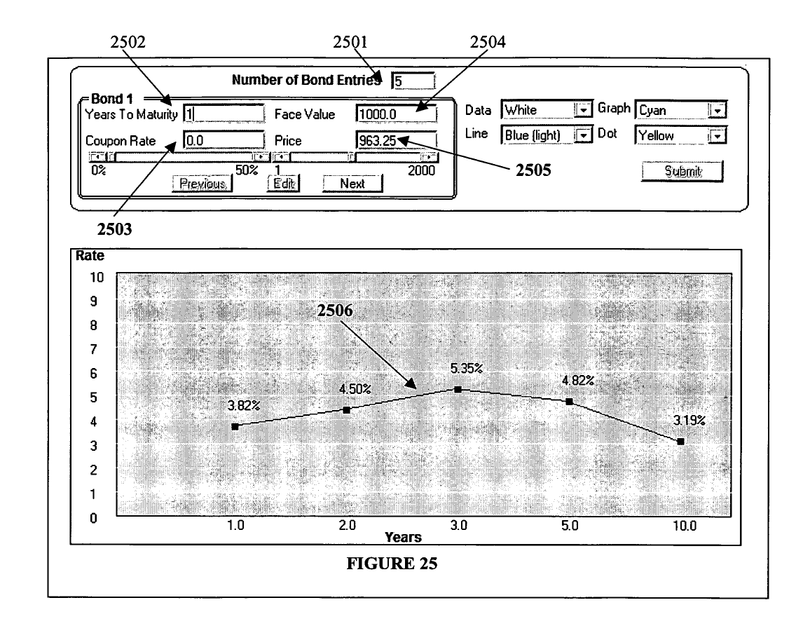

In this module, the user selects/provides the following inputs (refer to FIG. 25)
Number of bond entries (2501)
For each bond entry:
   years to maturity (2502)
   coupon rate (2503)
   face value (2504)
   current price (2505)

The user observes the following results/output (refer to FIG. 25)
Calculated spot rates or yields to maturity on all bond structures specified (2506)
Graphical output presents the spot rate or yield curve based on rates calculated
The user is able to change inputs by moving slider bars and can see the effect immediately on output

Module 6. Portfolio Strategy Analysis Modules

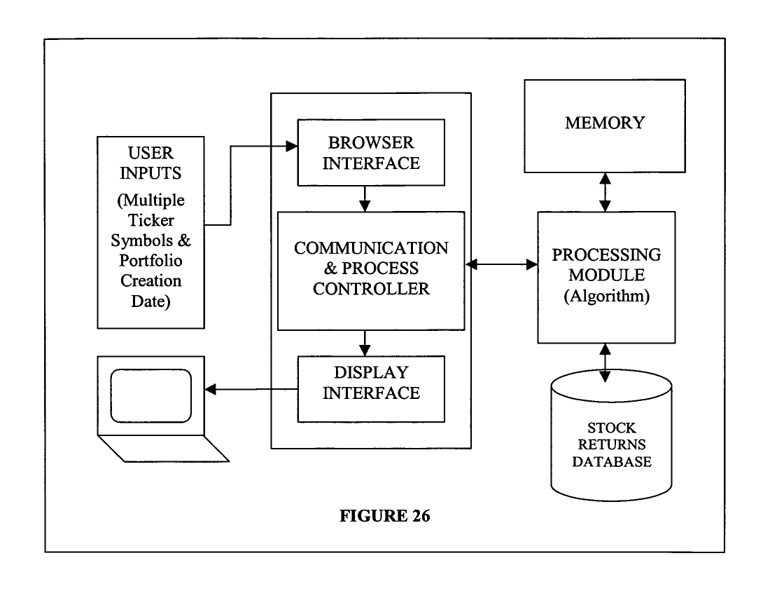

The Portfolio Strategy Analysis Modules (refer to FIG. 26) enable a user to calculate the risk of a portfolio and compare it with the market index as well as back test a portfolio investment strategy using real life actual trading data from the past before investing his or her own money. The tools also enable the user to measure the consistency of performance of an investment strategy on the basis of life of portfolio analysis over a period that follows the back test period, i.e., the strategy selection period.

The two integrated modules enable a user to select the stock and portfolio beta computation period from a set of choices in an interactive manner. The back test period is also left to the user. The back test module enables the user to compare the performance of different investment strategies and the life of portfolio module enables a test of their consistency of performance over time. Holding period return module computes the portfolio performance after adjusting for sales, purchases and cash distributions received by the user. Comparisons with a selected index are also provided.

These two integrated modules accept the ticker symbol and the beta estimation period provided by the user and reach into a historical stock price database. After extracting returns for the index and the ticker for the specified estimation period, they econometrically compute the beta of the portfolio. The computed beta is combined with the risk free rate (T-Notes) stored in a database to produce the projected rate of return for the portfolio. The back test module computes the beta adjusted/market index adjusted/unadjusted daily excess returns. Excess return is the difference between the return on the stock and the beta adjusted required return for the stock or the market return depending on the method chosen. Daily return differences are accumulated over the back test period. Beta estimation and back test periods do not overlap and the former precedes the latter. Total risk of the portfolio along with that of the market index is presented in the output. Statistical confidence level of superior or inferior performance is also reported for the portfolio in back test as well life of portfolio modules.

(a) Back Test Module

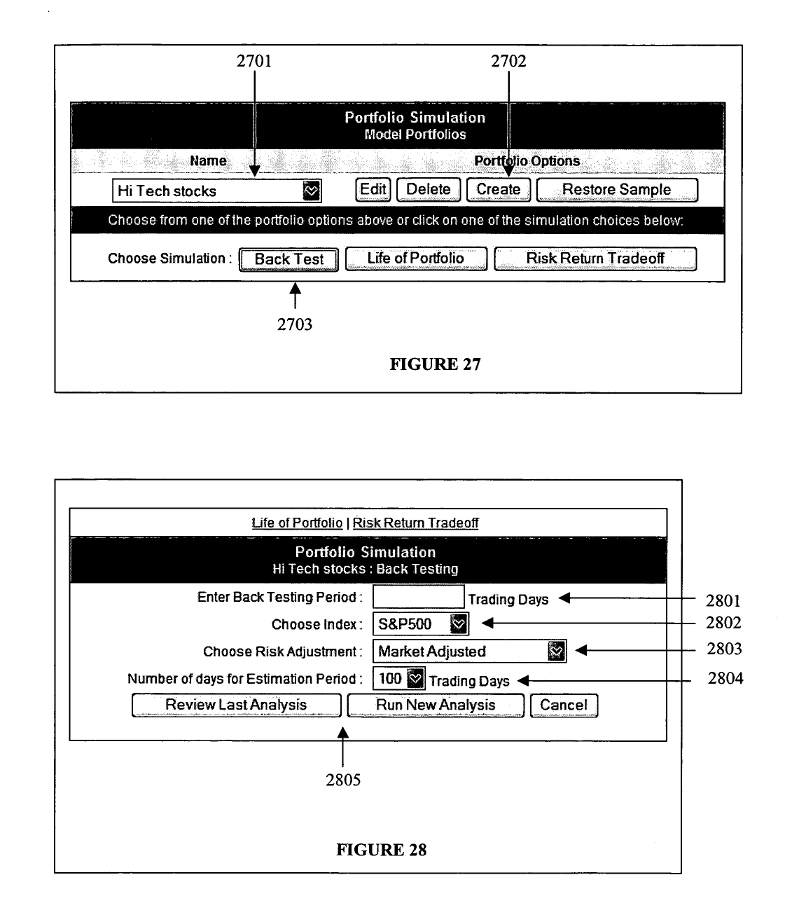

Step 1: Create or edit a portfolio to run a simulation (refer to FIG. 27)
Select a portfolio to edit or run a simulation (2701 & 2702)
Select Back Test option (2703)

Step 2: Enter inputs to run a simulation (refer to FIG. 28)
Enter back testing period in trading days (2801)
Choose an index for beta risk calculation (2802)
Choose a risk adjustment method or select unadjusted computations (2803)
Choose an estimation period for beta risk and related computations (2804)
Click on the “run new analysis” or “review last analysis” button for results (2805)

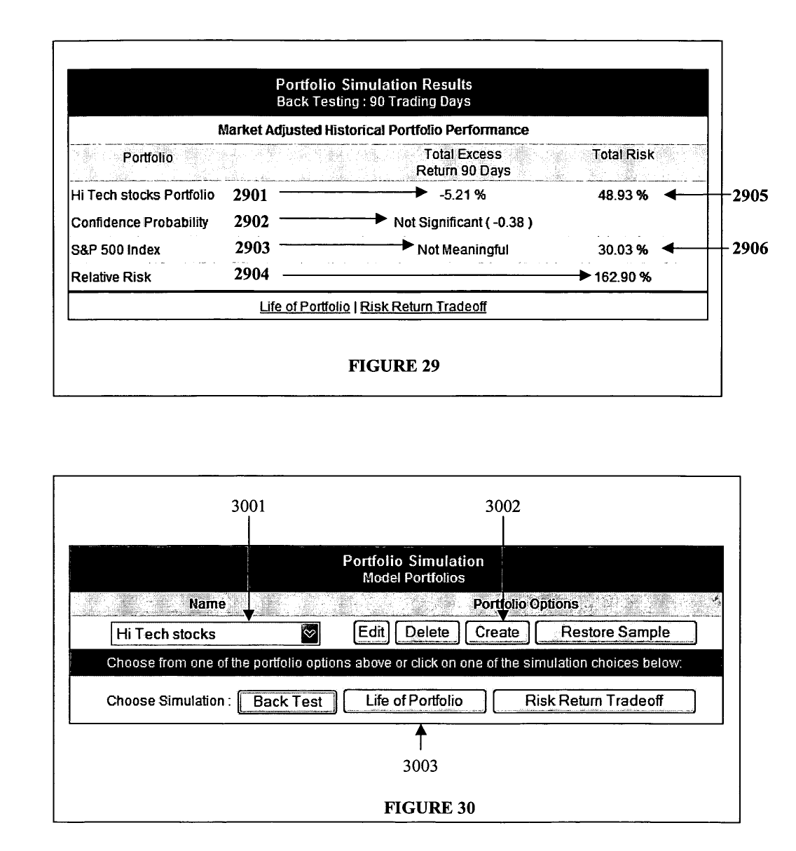

Step 3: The user observes the following results/output (refer to FIG. 29)
Daily risk adjusted or unadjusted excess returns (return on portfolio minus required risk adjusted or unadjusted return) added over the specified back test period (2901)
Confidence probability of total return being statistically different from zero (2902)
Index performance (2903)
Total risk of the portfolio (2905)
Total risk of the chosen index for comparison (2906)
Ratio of portfolio total risk and index total risk (2904)
The last output is automatically saved for later review.

(b) Life of Portfolio Module

Step 1: Create or edit a portfolio to run a simulation (refer to FIG. 30)
Select a portfolio to edit or run a simulation (3001 & 3002)
Select Life of Portfolio option (3003)

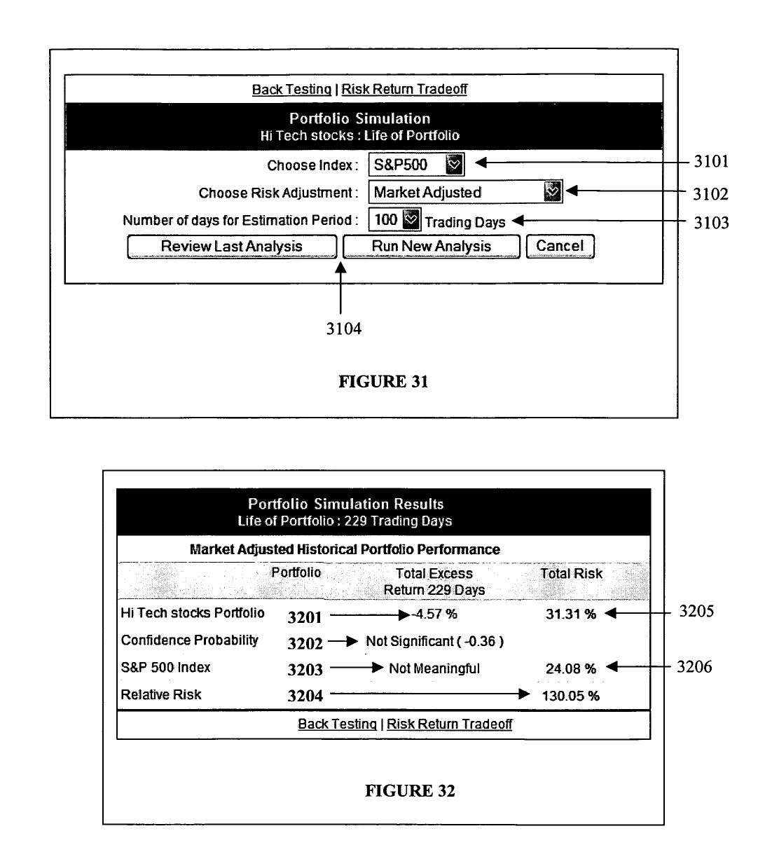

Step 2: Enter inputs to run a simulation (refer to FIG. 31)
Choose an index for beta risk calculation (3101)
Choose a risk adjustment method or select unadjusted computations (3102)
Choose an estimation period for beta risk and related computations (3103)
Click on the “run new analysis” or “review last analysis” button for results (3104)

Step 3: The user observes the following results/output (refer to FIG. 32)
Daily risk adjusted or unadjusted excess returns (return on portfolio minus required risk adjusted or unadjusted return) added over the specified back test period (3201)
Confidence probability of total return being statistically different from zero (3202)
Index performance (3203)
Total risk of the portfolio (3205)
Total risk of the chosen index for comparison (3206)
Ratio of portfolio total risk and index total risk (3204)
The last output is automatically saved for later review.

Module 7. Portfolio Risk Return Tradeoff

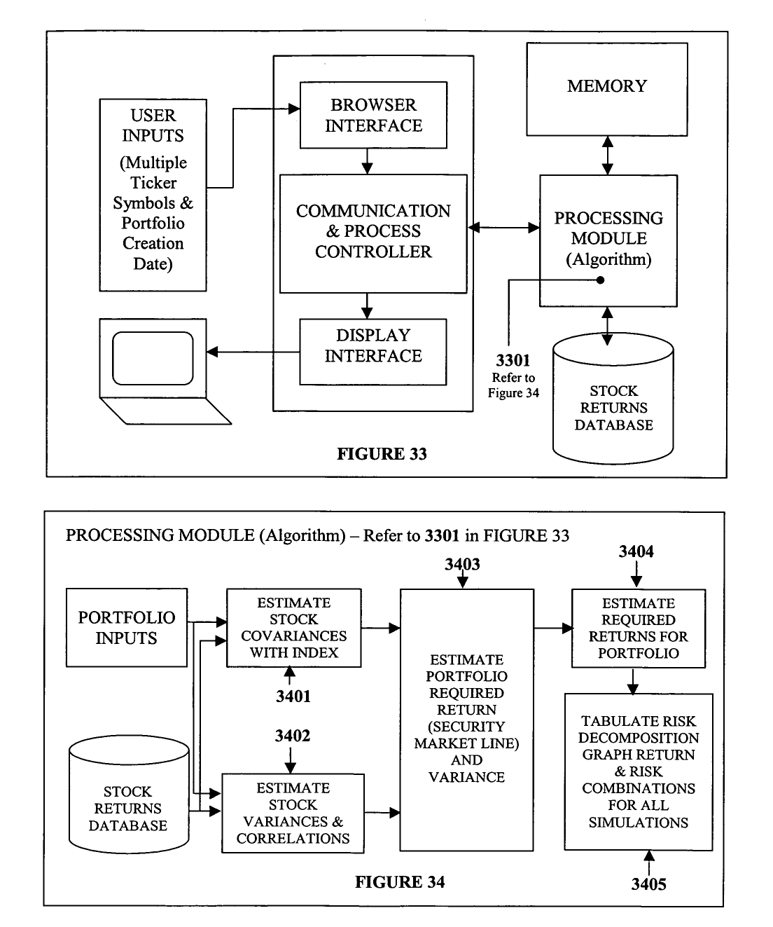

The Portfolio Risk Return Tradeoff (refer to FIG. 33) allows a user to analyze a portfolio and compare its risk and return with other portfolios that can be constructed with the same stocks in search of the best portfolio (3301). Also provides comparison with the selected index portfolio.

Under this highly integrated module, the user is able to select the beta risk estimation period from the multiple choices presented. The output shows the total risk as well as diversifiable risk of the user's portfolio along with the index portfolio. The graph in the risk-return space shows different portfolios that can be created with the same stocks simply by altering their portfolio weights. Given the user's portfolio risk, an improved portfolio that offers the highest return for same risk as user's portfolio is also shown, along with the stock weights and number of shares or each portfolio. Risk-return tradeoff is also presented in a bar chart. A portfolio with minimum risk created with the help of the user's stocks is also shown. The user can query the module for the chance of a specified portfolio gain or loss and also see its breakdown by individual stocks in tabular as well as graphical formats. Users can select among different risk adjustment methods.

The risk return module (refer to FIG. 34) computes the portfolio beta on the basis of estimation period specified by the user. Returns on portfolio stocks and market index are extracted from a database and beta estimation is done econometrically. Returns on portfolio stocks (Rⱼₜ) and market index are extracted from a database and beta (bⱼ) estimation (3401 & 3402) is done econometrically. The equation employed is:
Rⱼₜ−R_{Ft}=aⱼ+bⱼ(R_{Mt}−R_{Ft})+eⱼₜ
Where R_{Ft} is the risk-free rate and R_{Mt} is the return on the market index for period t. Beta is also confirmed with the following regression,
Rⱼₜ=aⱼ+bⱼ R_{Mt}+eⱼₜ

Portfolio beta is used to project the required portfolio return and the thirty day average T-note yield (R_{30T}) is used as the risk free rate for this purpose.
b_{P}=Σ wⱼ×bⱼ
Required portfolio return (3403)=RR_{P}=R_{30T}+b_{P}×RP_{M}
The last equation represents the Security Market Line (refer to FIG. 34). Where, wⱼ is the weight of stock j in a portfolio and RP_{M} is the risk premium on the market index portfolio, which defaults to 5% but is user controlled. Portfolio beta (b_{P}) is also used to compute the diversifiable risk and systematic risk of the portfolio (3405).
Diversifiable risk of portfolio=σ_{P}²−b_{P}²×σ_{M}²
Portfolio variance=σ_{P}²=Σ Σ wᵢ wⱼ Covᵢⱼ
Covariance of a pair of stocks=Covᵢⱼ=(1/n−1)Σ(Rᵢₜ−Rᵢ)(Rⱼₜ−Rⱼ)
Systematic risk of portfolio=b_{P}²×σ_{M}²
Market index variance σ_{M}²=(1/n−1)Σ(R_{Mt}−R_{M})²
R_{M}=(1/n)ΣR_{Mt}
Where R_{M} is the mean return of the market index (3404) and σ_{M}² is the variance of the market index returns. Rᵢ and Rⱼ are mean returns for stocks i and j respectively, calculated in a manner similar to the market index return.

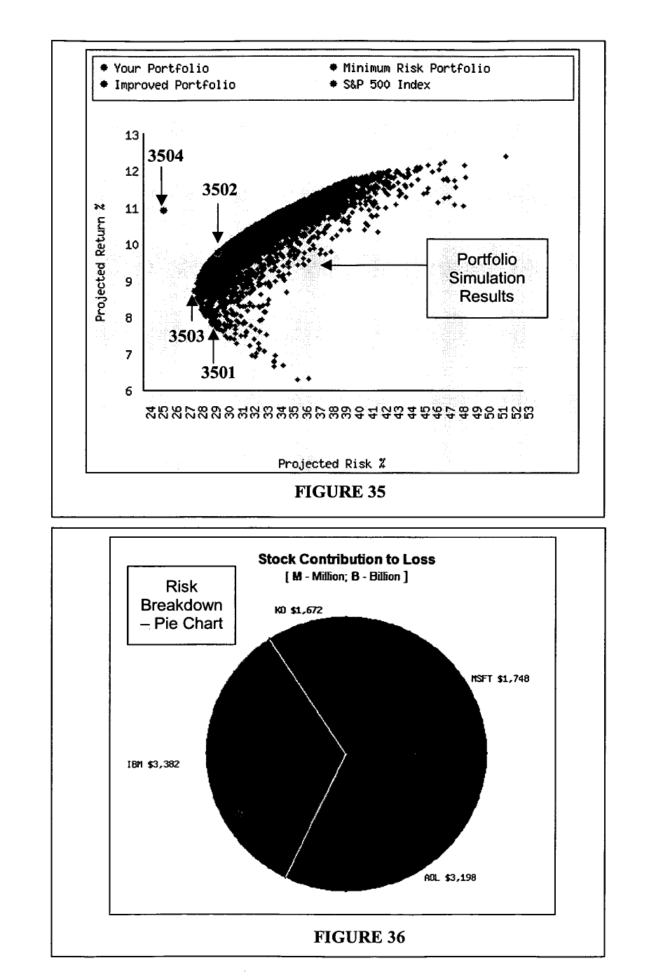

The model also simulates thousands of portfolios using the same stocks but with different portfolio weights in order to identify the efficient frontier. The equations used are:
b_{P}=Σ wⱼ×bⱼ
R_{Pt}=Σ wⱼ×RRⱼₜ
Portfolio variance (3403)=σ_{P}²=Σ Σ wᵢ wⱼ Covᵢⱼ
A graphical output (refer to FIG. 35), which spans the risk return space, with coordinates RR_{P} and σ_{P}, is presented that identifies simulated portfolios and their risk and return profiles. The graph shows the client's original portfolio (3501), an improved portfolio (3502) that has the same risk as the client's portfolio but highest return possible for the given stocks, a minimum variance portfolio (3503), and the market index portfolio (3504).

The output also includes information about the four portfolios on the basis of their risk return tradeoff, i.e., Sharpe ratio, which is shown in a bar graph for all four portfolios.
Sharpe ratio=(RR_{P}−R_{30T})÷σ_{P}

The user can also query the module to project the probability of loss or gain as a result of investing in any of the three portfolios (excluding the market index) over a specified period.

Total risk and beta driven projected return are used to estimate the gain/loss probabilities using a normal distribution assumption for stock and portfolio returns. The results of the gain/loss probability estimator are presented in numerical form as well as bar and pie charts (refer to FIGS. 40 & 36) for ease of understanding. The module integrates different financial models into one super-process and relies upon the historical database of stock prices to compute necessary parameters which are estimated on the basis of statistical and econometric analyses.

(a) Risk Return Tradeoff Module

Step 1: Create or edit a portfolio to run a simulation (refer to FIG. 30)
Select a portfolio to edit or run a simulation (3001 & 3002)
Select Risk Return Tradeoff option (3003)

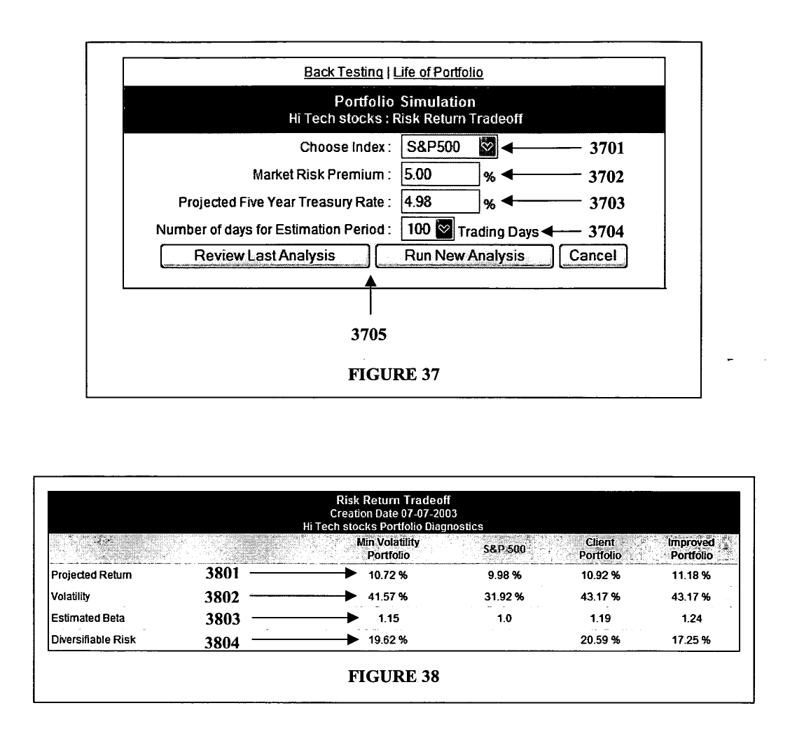

Step 2: Enter inputs to run a simulation (refer to FIG. 37)
Choose an index for beta risk calculation (3701)
Override or accept the default market risk premium (3702) Override or accept the default risk free rate based on average T-Note yield (3703)
Choose an estimation period for beta risk and related computations (3704)
Click on the “run new analysis” or “review last analysis” button for results (3705)

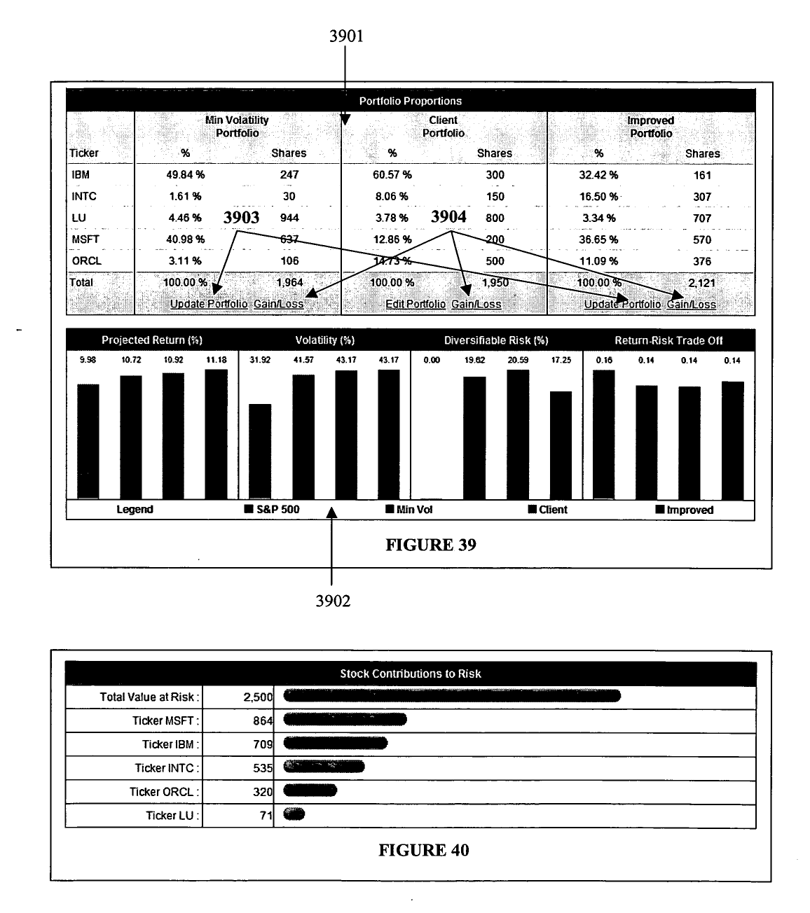

Step 3: The user observes the following results/output (refer to FIG. 38)
Tabular output 1 containing:
   projected return based on portfolio beta risk (3801)
   total portfolio risk or volatility (3802)
   estimated portfolio beta (3803)
   diversifiable risk based on projected beta (3804)
The output in FIG. 38 pertains to each of the following four portfolios:
   client or user portfolio
   selected index
   minimum variance portfolio identified with the help of randomly generated simulations, and
   improved portfolio that has the same volatility as the client portfolio but highest return possible given portfolio stocks
Tabular output 2 containing (refer to FIG. 39):
   number of shares for each ticker (3901)
   proportion of total portfolio represented by each ticker (3901)
The output pertains to each of the following four portfolios:
   client or user portfolio
   minimum variance portfolio identified with the help of randomly generated simulations
   and improved portfolio that has the same volatility as the client portfolio but highest return possible given portfolio stocks
Graphical output 1 showing bar charts (3902):
   of projected portfolio return based on beta risk
   of computed volatility
   of extent of diversifiable risk
   risk return tradeoff or Sharpe ratio
The output pertains to each of the following four portfolios:
   client or user portfolio
   selected index
   minimum variance portfolio identified with the help of randomly generated simulations,
   and improved portfolio that has the same volatility as the client portfolio but highest return possible given portfolio stocks
Graphical output 2 (refer to FIG. 35) showing a scatter plot containing portfolios consisting of client-portfolio stocks with different portfolio proportions or weights generated with the help of a random distribution driven simulation. The graph shows, in the projected risk and return framework (or x-y axes):
   client or user portfolio (3501)
   selected index (3504)
   minimum variance portfolio identified with the help of randomly generated simulations (see below) (3503)
   improved portfolio that has the same volatility as the client portfolio but highest return possible given portfolio stocks (3502)

After completing the analysis, the user can save the portfolio proportions calculated for the minimum variance portfolio or the suggested improved portfolio and update (3903) his original portfolio allocations on the basis of the results of the risk return tradeoff module.

The last output is automatically saved for later review.

The user may also estimate the probability or chance of a projected gain or loss from any of the three portfolio (3904), except the market index, over a specified period. See (b) below.

(b) Portfolio Gain/Loss Estimator Module

The user selects/provides the following inputs (see Module 13 for more details):
Choose gain or loss specification from a dropdown list box
Specify the gain or loss amount
Accept the default projected portfolio annual return calculated on the basis of beta risk from part (a) above, or override the same
Accept the default portfolio volatility calculated in part (a) above, or override the same
Specify the period over which the chance or probability of gain or loss is to be estimated
Click on the submit button

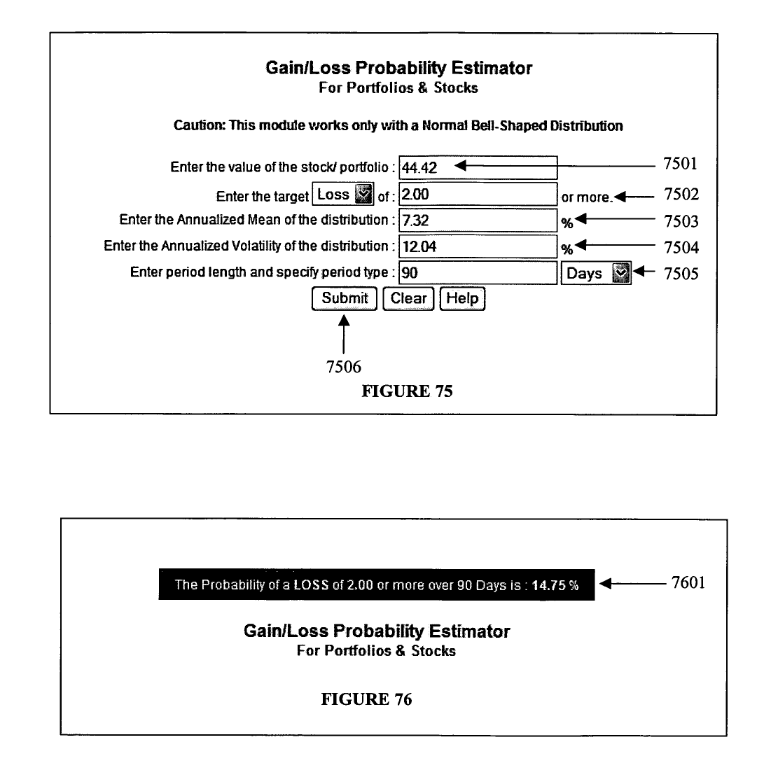

Step 1: The module fills in the following inputs automatically (refer to FIG. 75)
Value of the portfolio (7501)
Annualized mean of the distribution (7503)
Annualized volatility of the distribution (7504)

Step 2: The user selects/provides the following inputs
Specify the amount and choose Gain or Loss (7502)
Enter period length and specify type (7505)
Click on Submit button (7506)

Step 3: The user observes the following results/output (refer to FIG. 76)
The numerical output returns the chance or probability of losing or gaining the specified amount over the specified period (7601)
The first graphical output (refer to FIG. 40) shows the breakdown of the total gain or loss by the ticker symbol, giving the user an idea of how much each stock contributes to potential gain or loss in a sideways bar chart
The second graphical output presents the information in a pie chart format (refer to FIG. 36) for an alternative visualization of loss or gain by ticker

Module 8. IPO Simulator Module

The IPO Simulator module enables users to choose IPOs (initial public offerings) from a dataset of all IPOs since 1996 with the help of a screener and analyze their performance on the day of the IPO, as well as surrounding days up to six months and more for a longitudinal evaluation of past IPOs, before investing in similar IPOs in future.

The screener enables the user to specify criteria such as size, issue manager, exchange listing, date of issue etc. and analyze the performance of the resulting dataset. IPOs issued on different calendar dates are aligned according to the issue date so that their performance after the issue date can be evaluated as a group, statistically and econometrically. Users can select the beta estimation period and can also select from different risk adjustment methods. The risk adjusted performance is shown graphically for the date of the issue as well as the days surrounding the issue date and longer period for longitudinal analysis. Confidence level or probability of results is also reported.

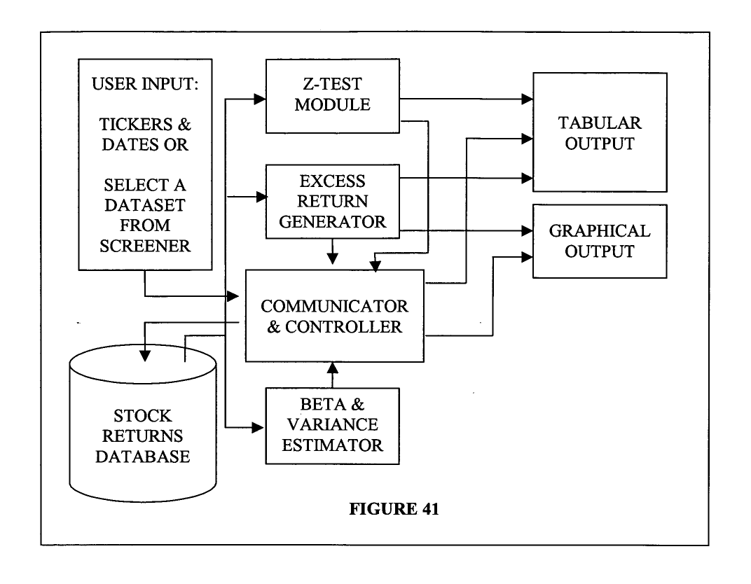

The module (refer to FIG. 41) collects the dataset of tickers and issue-dates and aligns them according to the issue-date. All issue-dates are assigned a counter of ‘0’. Once all tickers have been aligned the module estimates beta for each stock according to the estimation period and index specified by the user. The market model equation, shown below, is used for beta (βⱼ) estimation.
Rⱼₜ=αⱼ+βⱼ R_{Mt}+εⱼₜ

Where Rⱼₜ is the return on an individual stock, j, for day t. R_{Mt} is the corresponding return on the market index. αⱼ is a constant and εⱼₜ is the random error.

Once the beta has been determined for each stock, the actual daily return for each stock in the dataset is differenced from the projected return computed with the help of the stock's beta (βⱼ).
eⱼₜ=Rⱼₜ−aⱼ−bⱼ R_{Mt}
The excess or differenced return (eⱼₜ) is calculated for all stocks for all days in the prediction or test period following the issue date (day 0). a and b denote estimates from the regression equation.

Excess returns are accumulated at the ticker level over the interval specified in the window following the IPO date, as well as the longitudinal prediction or test period specified by the user.
ER_{jt,t+T}=Σ_{τ=t to t+T} e_{jτ}
Statistical significance is reported on the basis of normalized errors using the standard normal z-test after accumulating over all firms in the sample across the window.
Var[Σ_{τ=t to t+T} e_{jτ}]=Vⱼ²[T+(T²/ED)+(Σ_{τ=t to t+T} R_{Mτ}−T(avgR_{M}))²/Σ_{τ=1 to ED}(R_{Mτ}−T(avgR_{M}))²]
Where Vⱼ² is the error variance for firm j and ED is the number of days in estimation period for beta. Given n firms in the sample,
Z=(1/√n)τ_{j=1 to n} [Σ_{τ=t to t+T} e_{jτ}/√Var[Σ_{τ=t to t+T} e_{jτ}]]

The module output can be used to ascertain whether the IPOs in the dataset as a group display a pattern of superior or inferior performance after the issue-date. Confidence probabilities for excess returns are also reported. Excess returns are also presented graphically for ease of interpretation.

The user selects/provides the following inputs:

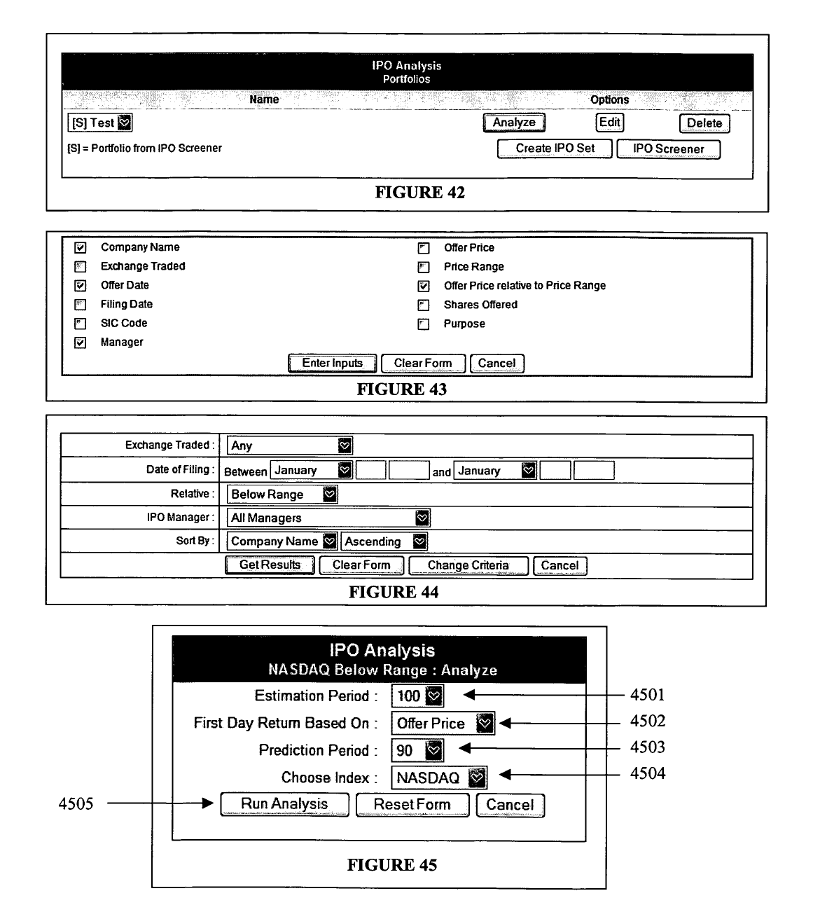

Step 1: The user builds a dataset of initial public offerings (IPOs) from an IPO screener linked to a database of past IPOs, or create his or her own from personal and other sources.
The user specifies IPO tickers or selects from a database (refer to FIG. 42)
The user selects screening variables to identify an IPO dataset for analysis from the database. (refer to FIGS. 43 & 44)

Step 2: Specify inputs for data analysis (refer to FIG. 45)
Enter the beta risk estimation period (4501)
Choose how the first trading day's return will be calculated—offer price to close or open price to close (4502)
Enter the prediction or test period, i.e., period after the issue date for long-term performance analysis (4503)
Choose a market index for beta computation (4504)
Click “run analysis” button for results (4505)

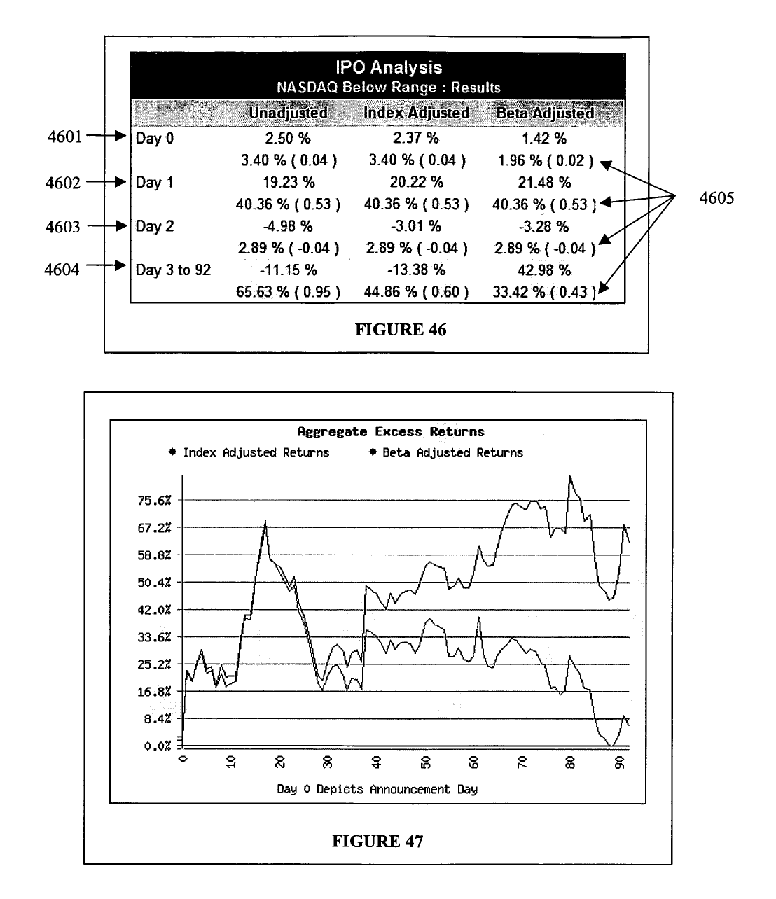

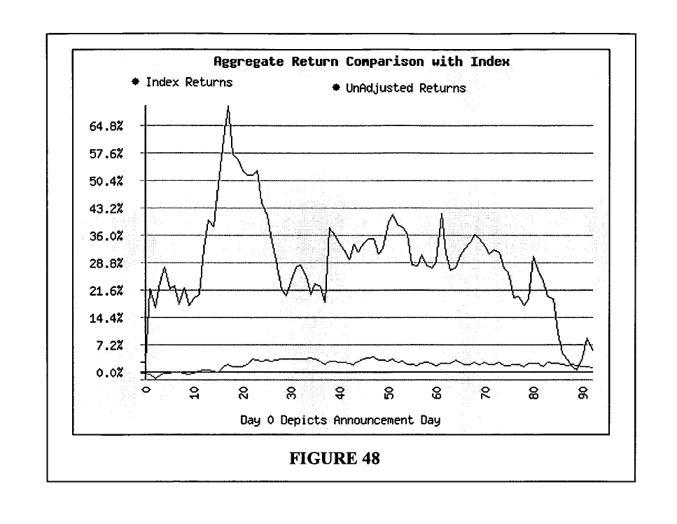

Step 3: The user observes the following results/output:
A tabulated output (refer to FIG. 46) that shows:
   average return for day 0 or date of issue for the entire dataset (4601)
   average return for day 1 or one day after the issue date for the entire dataset (4602)
   average return for day 2 or two days after the issue date for the entire dataset (4603)
   average return cumulated from day 3 until the end of the specified prediction or test period (4604)
   for each of the four average returns described above, the confidence probability that the average return is statistically different from zero along with the z-statistic in parentheses (4605)
A graphical output (refer to FIG. 47) that shows the accumulated daily performance for the entire sample over a time line from the date of issue until the end of the prediction or test period. It is presented in two ways:
   adjusted for beta risk and market index return
   adjusted for market index return but not beta risk
A second graphical output (refer to FIG. 48) shows the accumulated daily performance over a time line for the entire sample from the date of issue until the end of the prediction or test period. It is presented in two ways:
   unadjusted average raw return for the IPO dataset
   average raw return for the market index

Module 9. Announcement Effect or Event Effect Simulator

The Announcement Effect or Event Effect Simulator module enables users to analyze the effect of corporate events and announcements such as mergers and takeovers, dividend increases and reductions, stock splits, senior manager resignations, trading in company stock by officers and directors etc. on the price of a company's stock.

In this module, users can enter stock tickers or select tickers from a dataset on the basis of a screener. Announcement and event dates are likely to differ for stocks and they are first aligned according to the event or announcement date so that their performance before and after the event or announcement date can be evaluated as a group, statistically and econometrically. Users select the beta estimation period and also select among different risk adjustment methods. Risk adjusted performance is shown as a graphical output for the date of the announcement or event as well as the days surrounding the event or announcement date (both before and after), and longer periods for a longitudinal analysis. Confidence level of results is also reported.

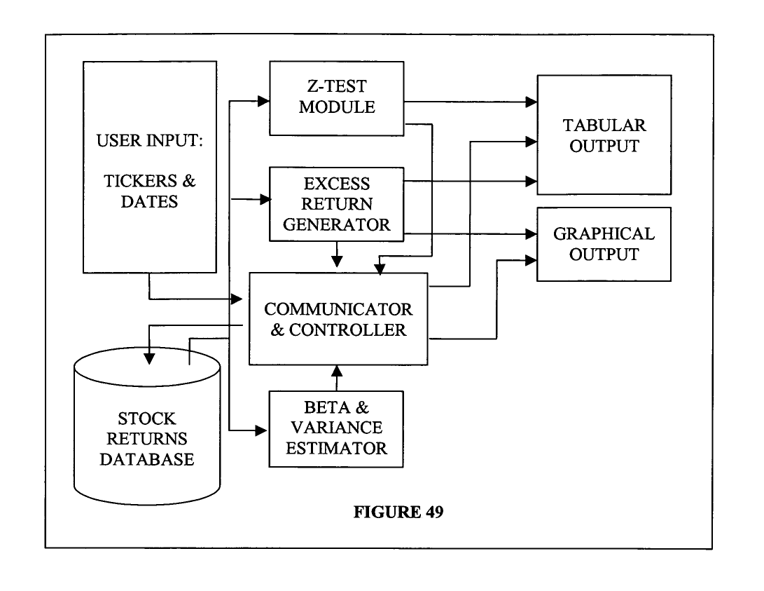

This module (refer to FIG. 49) collects the dataset of tickers and announcement/event dates and aligns them according to the event date. All event dates are assigned a counter of ‘0’. Once all tickers have been aligned. The date immediately before the event date is assigned a counter of −1 and the date immediately after the event date is assigned a counter of +1, and so on. The module estimates beta-risk for each stock according to the estimation period and index specified by the user. After beta has been determined for each stock, actual daily return for each stock in the dataset is differenced from the stock's return computed with the help of stock's beta. The excess or differenced return is calculated for all stocks for all days in the prediction or test period following the event date (day 0).

Excess returns so computed for each ticker are then averaged for all stocks in the dataset for a statistically meaningful interpretation of results. Accumulated daily excess returns are reported for the event date and a window surrounding the event date (up to two days on either side) as well as the longitudinal prediction or test period specified by the user. The output shows whether the stocks in the dataset as a group display any pattern of abnormal performance around and after the event date. Confidence probabilities for excess returns are also reported. Excess returns are also presented graphically for ease of interpretation. A window of up to 40 days before the event date is used as a separation period between beta estimation and measurement of the effect of the event on the average stock in the dataset. The market model equation, shown below, is used for beta (βⱼ) estimation.
Rⱼₜ=αⱼ+βⱼ R_{Mt}+εⱼₜ
Where Rⱼₜ is the return on an individual stock, j, for day t. R_{Mt} is the corresponding return on the market index. αⱼ is a constant and εⱼₜ is the random error.

Once the beta has been determined for each stock, the actual daily return for each stock in the dataset is differenced from the projected return computed with the help of the stock's beta (βⱼ).
eⱼₜ=Rⱼₜ−aⱼ−bⱼ R_{Mt}
The excess or differenced return (eⱼₜ) is calculated for all stocks for all days in the prediction or test period following the issue date (day 0). a and b denote estimates from the regression equation.

Excess returns are accumulated at the ticker level over the interval specified in the window following the IPO date, as well as the longitudinal prediction or test period specified by the user.
ER_{jt,t+T}=Σ_{τ=t to t+T} e_{jτ}
Statistical significance is reported on the basis of normalized errors using the standard normal z-test after accumulating over all firms in the sample across the window.
Var[Σ_{τ=t to t+T} e_{jτ}]=Vⱼ²[T+(T²/ED)+(Σ_{τ=t to t+T} R_{Mτ}−T(avgR_{M}))²/Σ_{τ=1 to ED}(R_{Mτ}−T(avgR_{M}))²]
Where Vⱼ² is the error variance for firm j and ED is the number of days in estimation period for beta. Given n firms in the sample,
Z=(1/√n)τ_{j=1 to n} [Σ_{τ=t to t+T} e_{jτ}/√Var[Σ_{τ=t to t+T} e_{jτ}]]

The module output can be used to ascertain whether the IPOs in the dataset as a group display a pattern of superior or inferior performance after the issue-date. Confidence probabilities for excess returns are also reported on the basis of significance of the z-statistic. Excess returns are also presented graphically for ease of interpretation.

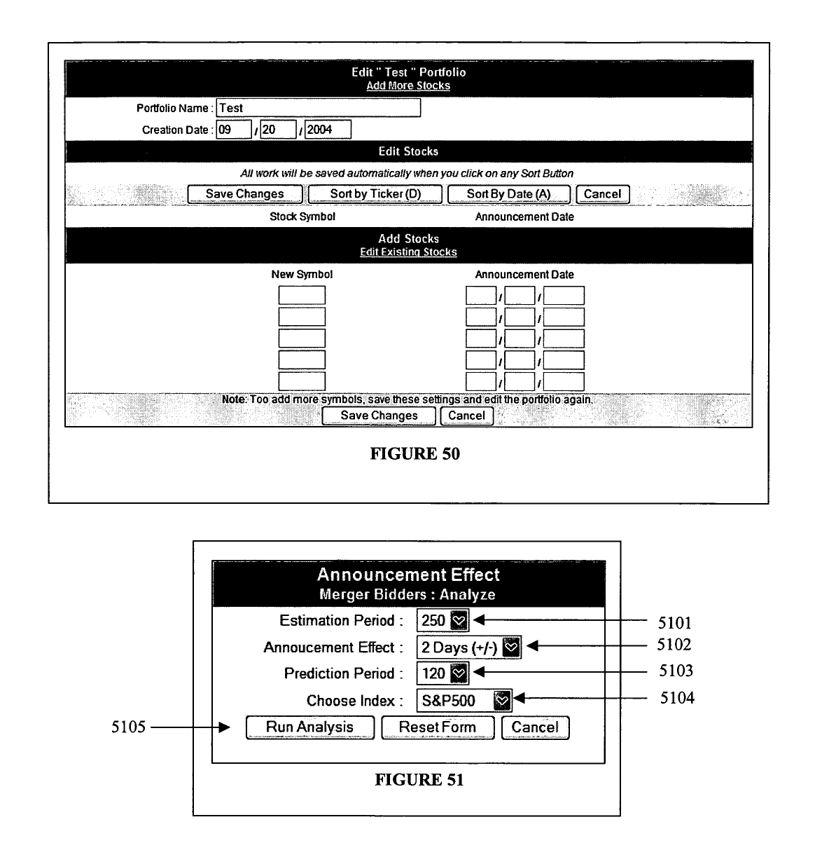

Step 1: The user create his or her own dataset from personal and other sources
Dataset of ticker symbols and dates from a screener linked to a database of past stock splits, mergers & acquisitions, dividend omissions, or create his or own from personal and other sources. The user specifies IPO tickers and dates (refer to FIG. 50)

Step 2: User specifies inputs for data analysis (refer to FIG. 51)
Enter the beta risk estimation period (5101)
Choose how the first trading day's return will be calculated—offer price to close or open price to close (5102)
Enter the prediction or test period, i.e., period after the issue date for long-term performance analysis (5103)
Choose a market index for beta computation (5104)
Click “run analysis” button for results (5105)

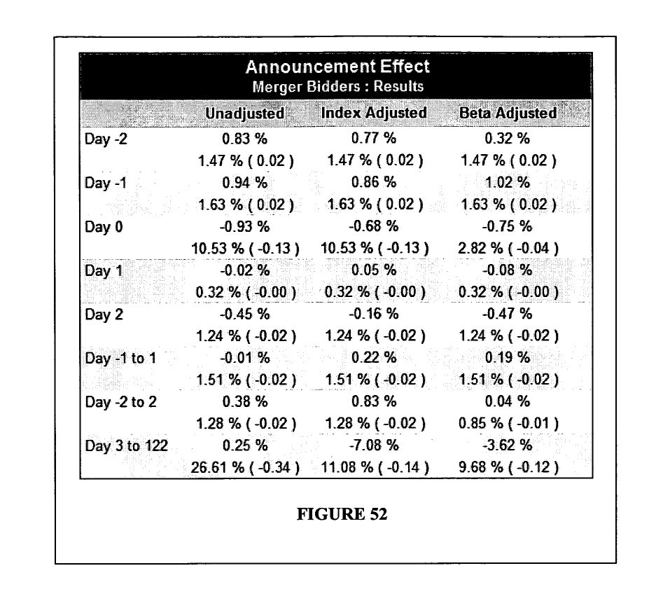

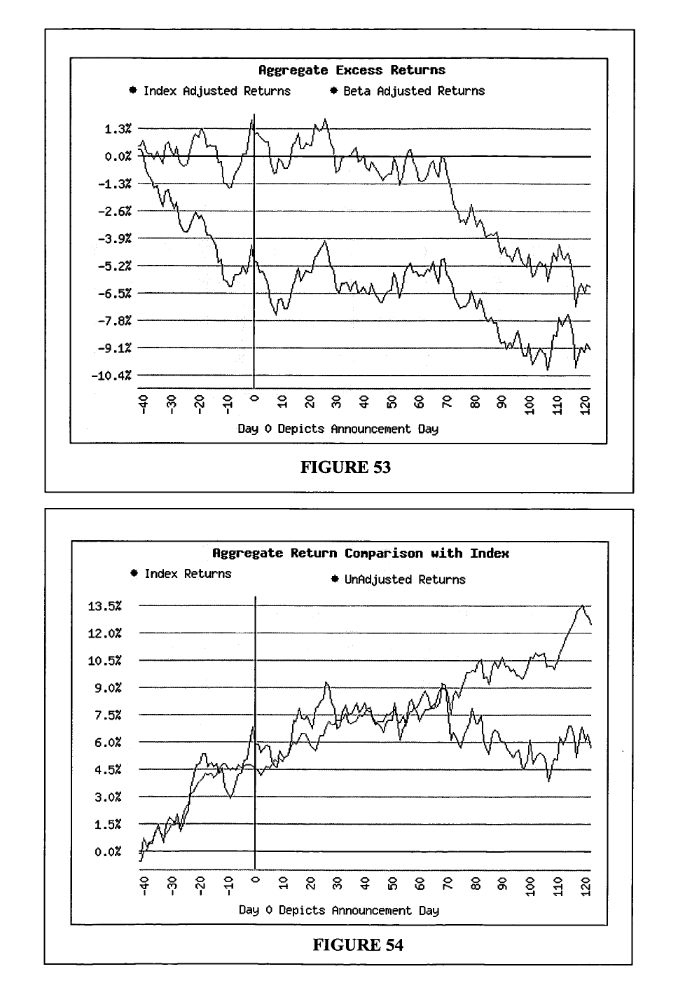

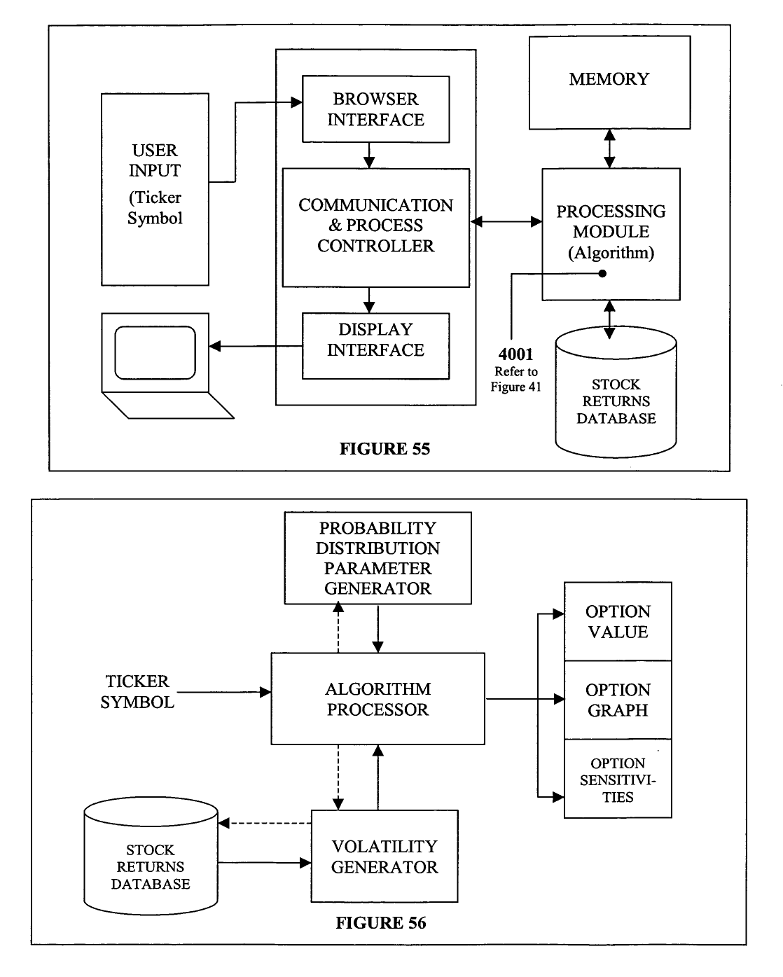

Step 3: The user observes the following results/output
A tabulated output (refer to FIG. 52) that shows:
   average return for each day in the selected window for the entire dataset
   average accumulated return for day −1 to day +1 of the window for the entire dataset
   average accumulated return for day −2 to day +2 of the window for the entire dataset
   average return cumulated from day 1, 2 or 3 until the end of the specified prediction or test period
   for each of the four average returns described above, the confidence probability that the average return is statistically different from zero along with the z-statistic in parentheses.
A graphical output (refer to FIG. 53) that shows the accumulated daily performance for the entire sample over the specified window and prediction period. It is presented in two ways:
   adjusted for beta risk and market index return
   adjusted for market index return but not beta risk
A second graphical output (refer to FIG. 54) shows the accumulated daily performance the entire sample over the specified window and prediction period. It is presented in two ways:
   unadjusted average raw return
   average raw return for the market index

Module 10. Option Valuation Module

The Option Valuation modules enable users to value options, both traded and non-traded. Executives and employees holding incentive stock options can value their long-term non-traded call options using these modules.

In this module (refer to FIGS. 55 & 56), the user can enter the ticker symbol, exercise price and life of an option, and the modules compute call and put values, as well as option sensitivities to inputs. They enable the user to value long term traded as well as non-traded incentive stock options. The output graphically shows how the value of the option changes with changing stock price. Modules included:
European Options Without Dividends Simulator
European Options With Dividends
American options Simulator
Binomial Options Simulator

After the user has entered all the required inputs or requested some of them to be entered automatically, the modules use different option pricing models to price an option. The Black-Scholes model is used for valuing European call and put options and estimating their sensitivities. The modules use the analytical method for valuing American options which have a non-zero probability of early exercise. Binomial option pricing model is used to estimate the value of options using an approximation model which is non-distributional whereas other models assume normality of stock returns. The modules are capable of estimating underlying stock volatility as well as the risk free rate of return required for option valuation. Results are presented in a tabulated as well as in graphical form, showing the relationship of an option (call or put) with the underlying stock price.

The Black-Scholes-Merton model is used for valuing European call and put options and estimating their sensitivities. When D=0, the following model reduces to the Black-Scholes for European options.

Call pricing:
C=e^{-DT} S N(d₁)−X e^{-rT} N(d₂)
Where N(·) is the cumulative normal probability function given the parameter value and,
d₁=[ln(S/X)(0.5σ²+r−D)/]σ√T]
d₂=d₁−σ√T
S is the current stock price, D is the continuous dividend yield, X is the option exercise price, T is the time remaining to expiration of the option, σ² is the volatility of the stock returns, and r is the risk free rate.

Put pricing:
P=C−e^{-DT S+X e}^{-rT}=X e^{-rT} N(−d₂)−S e^{-DT} N(−d₁)

The modules use the analytical method for valuing American options which have a non-zero probability of early exercise. It employs an iterative solution technique that satisfies the following set of conditions:

American Call:
C_{A}=C+M₂(S/SC)^{p} if S<S^{A}
C_{A}=S−X if S≧X
M₂=S^{C}=[1−e^{-DT} N(d₁)]/p
where S^{C} satisfies,
S^{C}−X=C(S^{A})+[1−e^{-DT} N(d₁)](S^{C}/p)
p=[1−m+√((m−1)²+4w)/2
m=2(r−D)/σ², w=2r/[σ²(1−e^{-rT})]
C(S^{C}) is the European call evaluated at the adjusted stock price of S^{C}. The remaining notations are the same as before.

American Put:
P_{A}=C+M₁(S/S^{P})^{p} if S>S^{P}
P_{A}=S−X if S≦X
Where S^{P} satisfies,
X−S^{P}=P(S^{P})−[1−e^{-DT} N(−d₁)](S^{P}/q)
M₁=S^{P}[1−e^{-DT} N(−d₁)]/q
q=[1−m−√((m−1)²+4w)/2
P(S^{P}) is the European put evaluated at the adjusted stock price of S^{A}. The remaining notations are the same as before.

Binomial option pricing model is used to estimate the value of options using an approximation model which is non-distributional whereas other models assume normality of stock returns. Define,
U_{B}=e^{σ√(Δt)}
D_{B}=U⁻¹
p_{U}[e^{(r-D)Δt}−D_{B}]/(U_{B}−D_{B})
The payoffs along a node-tree lattice is projected until option expiration and then discounted back at the risk free rate. Time until expiration is divided into small but equal intervals, Δt, with two possible outcomes—up or down stock price moves—at each node. The probability of an up move is represented by p_{U}. Expected option value is computed at each node and discounted back in time, one node at a time (Diag. A).

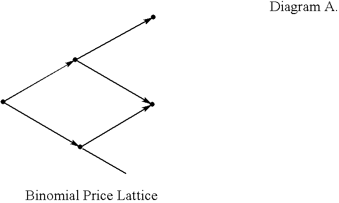

The modules are capable of estimating underlying stock volatility as well as the risk free rate of return required for option valuation. Results are presented in a tabulated as well as in graphical form, showing the relationship of an option (call or put) with the underlying stock price.

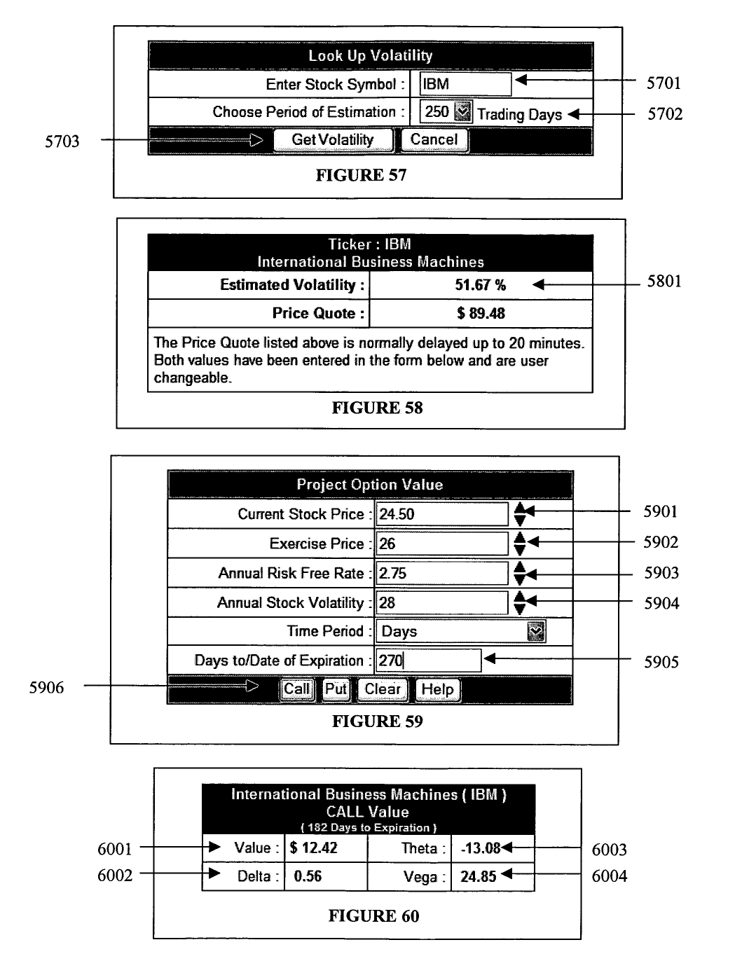

The user selects/provides the following inputs (refer to FIG. 57)

Step 1: The user selects/provides the following inputs for volatility calculation
Stock ticker symbol (5701)
Choose period of volatility estimation (5702)
Submit to calculate volatility (5703)

Step 2: The user observes the following output (refer to FIG. 58)

Estimate of return volatility for the specified ticker (5801)

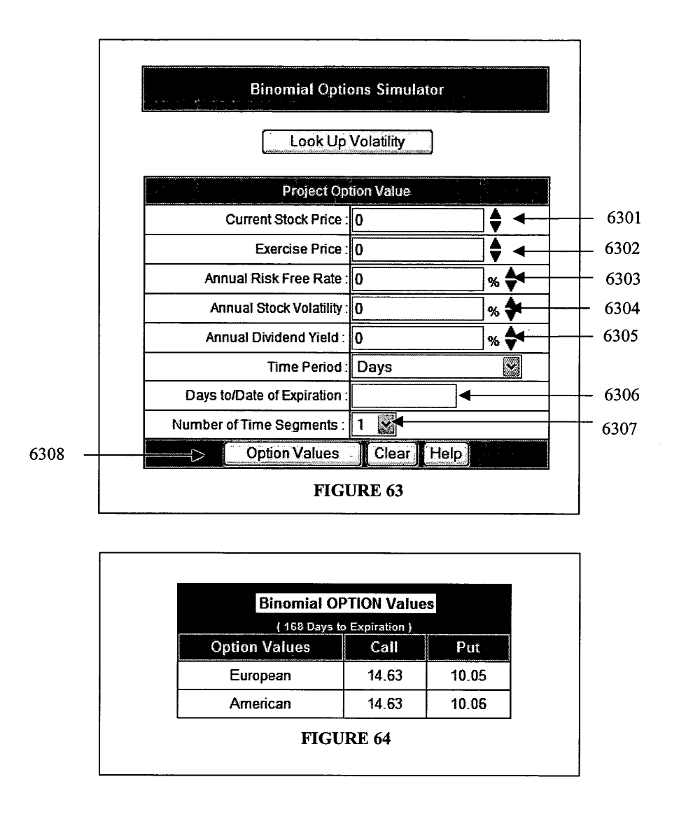

Step 3: The user selects/provided the following inputs for option value calculation (refer to FIGS. 59 & 63)
Current stock price (5901)
Option exercise price (5902)
Annual risk free rate (5903)
Annual stock volatility (filled in by previous step—user can override)
(5904)
Days to/date of expiration (5905)
Dividend yield for dividend paying stock (refer to FIG. 63, 6305)
Number of time segments needed for approximation purposes in the case of binomial model (refer to FIG. 63, 6307)
Click the “call” or “put” button for results (5906)

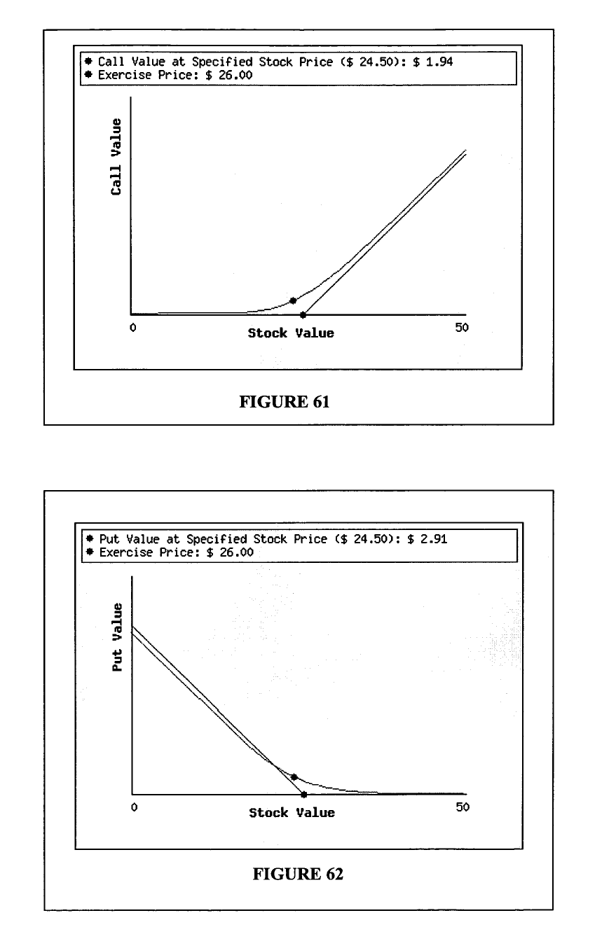

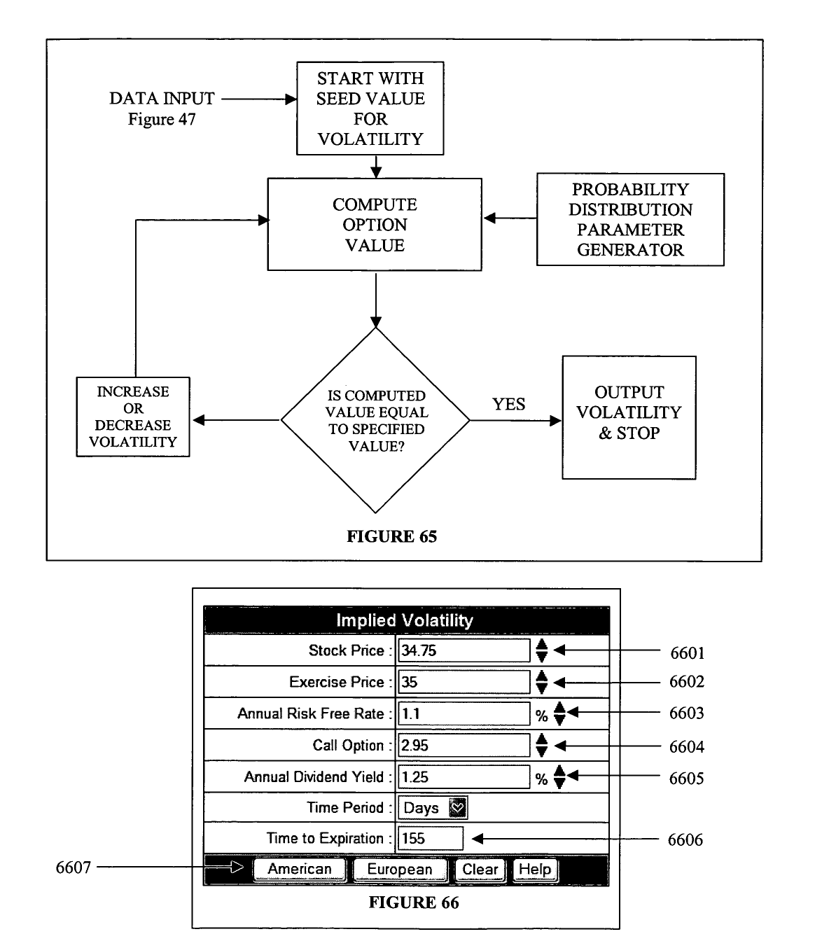

Step 4: The user observes the following results/output (refer to FIG. 60)
The tabulated output shows:
   estimated call or put value (6001)
   option delta, i.e., sensitivity to stock price changes (6002)
   option theta, i.e., sensitivity to time contraction (6003)
option vega, i.e., sensitivity to stock volatility changes (6004)
The graphical output shows:
   the relationship between call (refer to FIG. 61) or put (refer to FIG. 62) value and changing stock prices.
   the computed option value is identified on the graph, relative to the specified exercise price
   the graph of the option value against underlying stock price on the expiration date is also shown for reference
A tabular output shows the binomial option (refer to FIG. 64) values:
   European call and put values
   American call and put values

Module 11. Option Volatility Modules

The Option Volatility Modules enable users to calculate the volatility of stock returns from actual option prices for investing purposes. Volatility estimates from traded options can be used to value long-term non-traded options on the same stock such as incentive options.

In this module, the user enters the stock ticker symbol and the required inputs with the resulting output presenting the implied volatility computed under different dividend and exercise assumptions for a quick and easy comparison. Modules included:
Implied Call Value Simulator—European and American
Implied Put Value Simulator—European and American

After the user has specified all the inputs, the module (refer to FIG. 65) numerically searches for the volatility of the underlying stock's returns and uses the Black-Scholes formula for the European option assumption, and the analytical method for the American option assumption. When the volatility reaches the given tolerance range, the search ends and results are presented in a table. Volatility implied by an exchange traded option is then used for valuing long-term non-traded incentive options commonly awarded to employees, officers, executives and directors of public companies. The latter are difficult to value in the absence of an implied volatility estimate. Results of the implied volatility module can also be verified with the help of the historical stock return volatility computed in the gain/loss probability estimation module under stock valuation analysis described in Module 4.

The user selects/provides the following inputs (refer to FIG. 66)
Stock price (user has the option to enter the ticker symbol and let the system look up the stock price) (6601)
Option exercise price (6602)
The module fills in average risk free yield based on T-Notes from a database. User can override the risk free rate (6603)
Option price (6604)
The module fills in annualized dividend yield on the stock. User can override dividend yield (6605)
Days to/date of expiration (6606)
Click the “American” or “European” button for results (6607)

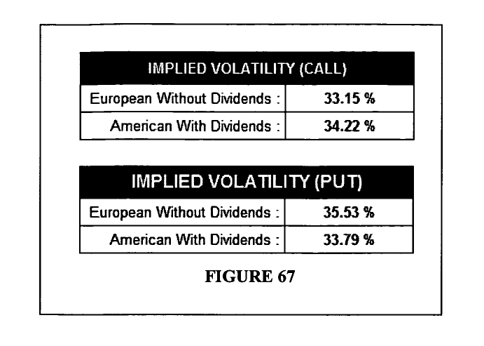

The user observes the following results/output (refer to FIG. 67)
The tabulated output shows:
   implied volatility based on early exercise (American) assumption
   implied volatility based on no early exercise (European) assumption

Module 12. Forward Option Value Simulation with Probabilities Module

This module allows a user to estimate the value of an option in the future, before its expiration, and estimate its chance of achieving a specified value or more (less).

The module simulates the value of call and put options at a specified date in the future and uses a simulation that draws random (distribution) numbers for future stock prices and computes thousands of projected option values under different scenarios. It arranges option values in the form of a probability distribution and enables the user to query the module for the chance of attaining specified (or more/less) option values. The output includes a graphical chart of various option values for a visual understanding of the probability chart. Modules included:
European Options (No Dividends) Advanced Simulation
European Options (With Dividends) Advanced Simulation
American Options (With Dividends) Advanced Simulation

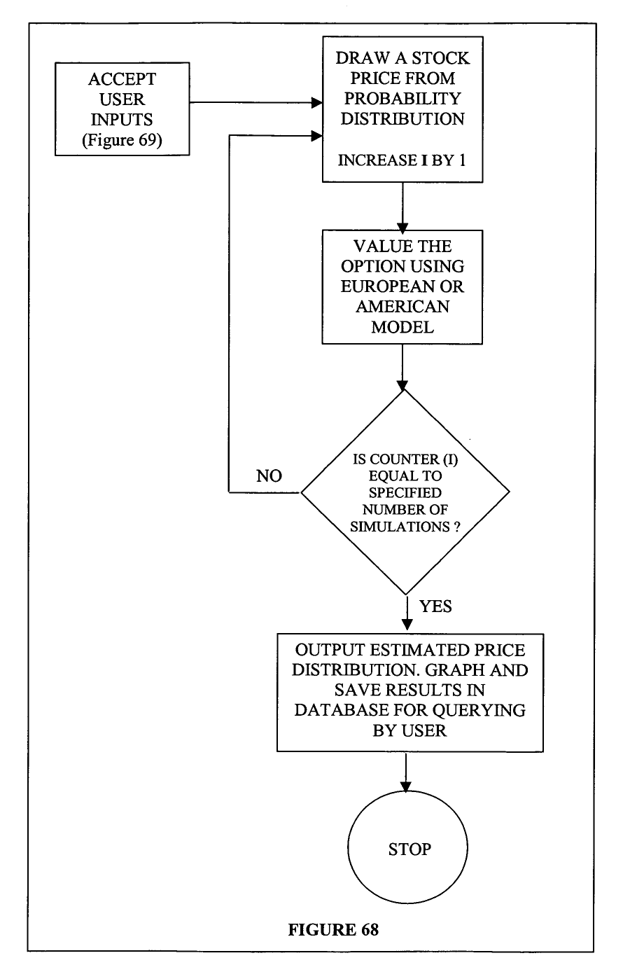

The module (refer to FIG. 68) computes the value of an option at a future date specified by the user, before the expiration of the option. The user also specifies other required inputs. The user can choose to have the module estimate stock return volatility and the risk free rate. The module uses the Black-Scholes and analytical American option pricing models to determine the values of options (call or put) at a future date. In addition to estimating a point value, the module simulates many stock prices at the future date assuming a normal return distribution and beta-risk driven projected return. Beta-risk and projected return are computed on the fly. For details of this process see Module 4, Stock Valuation. After randomly sampling different future stock prices, an option is valued repeatedly for each stock price sampled generating a probability distribution of option values. Future stock as well as call and put option price distributions are provided as outputs in the form of bar graphs. The user can query the module to estimate the probability of the option value exceeding or not exceeding a target value at the future date. This powerful module integrates econometric beta-risk estimation, stock volatility computation, Monte-carlo simulation of stock and option values along with manipulation of returns and T-note yields databases for a complete solution to an option buy, sell or hold decision.

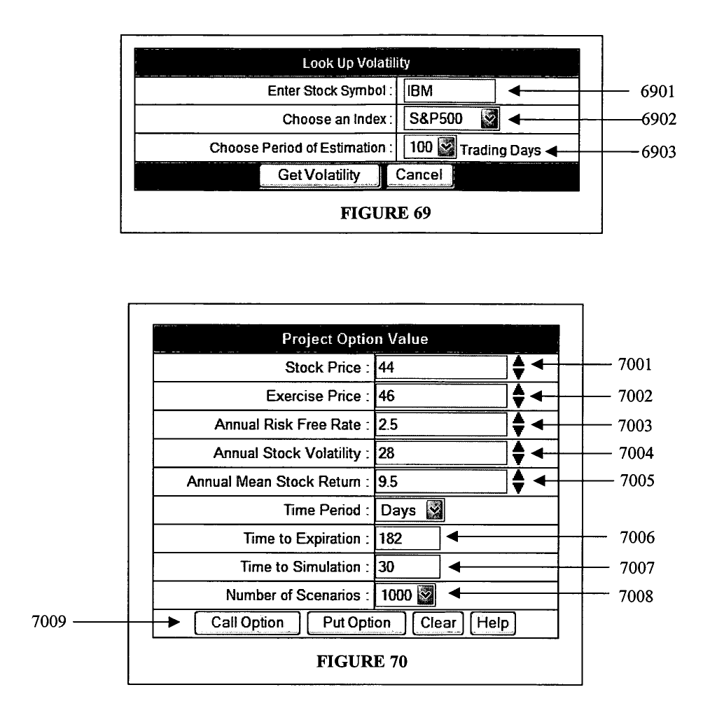

Step 1: The user selects/provides the following inputs (refer to FIG. 69)
Stock ticker symbol (6901)
Market index for beta risk and required return on stock (6902)
Estimation period for beta risk and volatility computation (6903)

Step 2: The module fills in some values and requires remaining values (refer to FIG. 70)
The module fills in current stock price (7001)
User enters option exercise price (7002)
User enters risk free rate (7003)
Module fills in stock volatility (7004)
Module fills in projected annualized stock return based on beta risk (7005)
User enters days to/date of expiration (7006)
User enters time to simulation, i.e., future option projection and probability estimation date (7007)
User selects number of simulations or scenarios to be executed (7008)
Click the “call” or “put” option button for results (7009)
The module fills in annualized dividend yield on the stock for dividend paying stocks

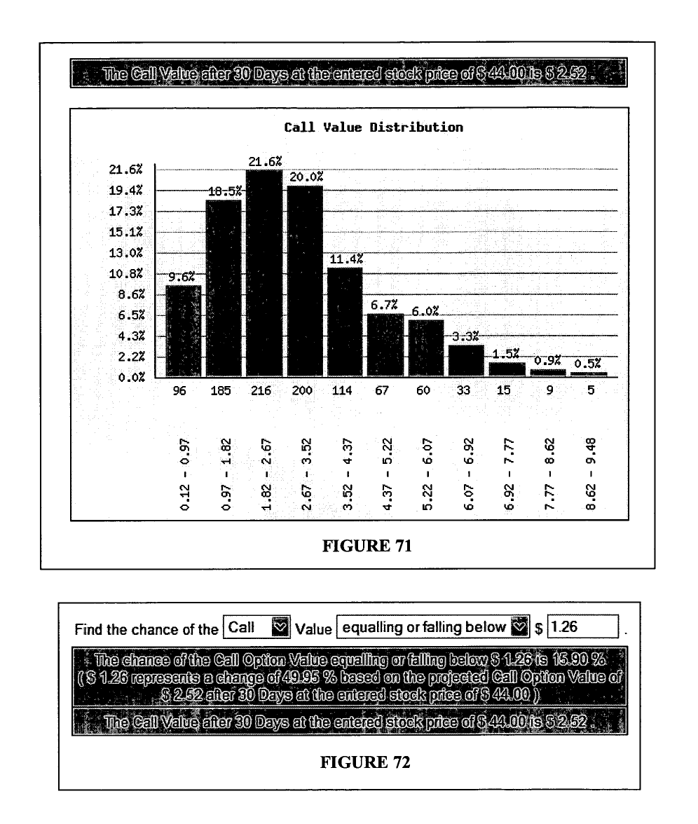

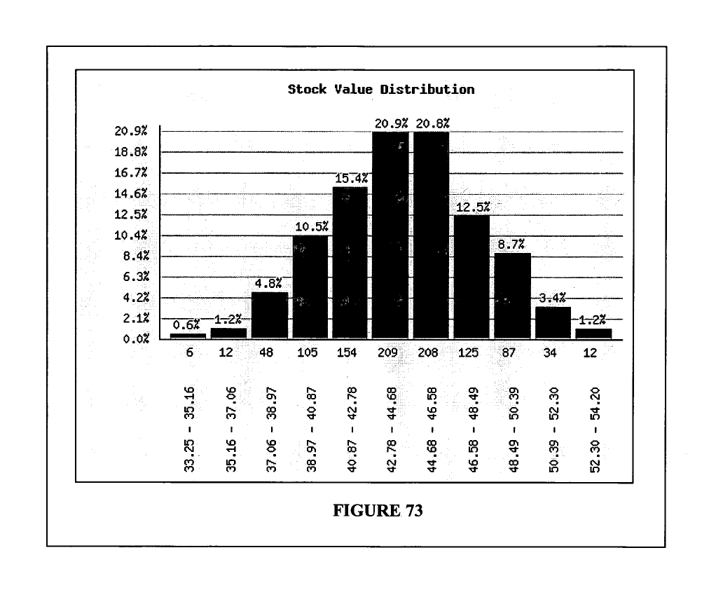

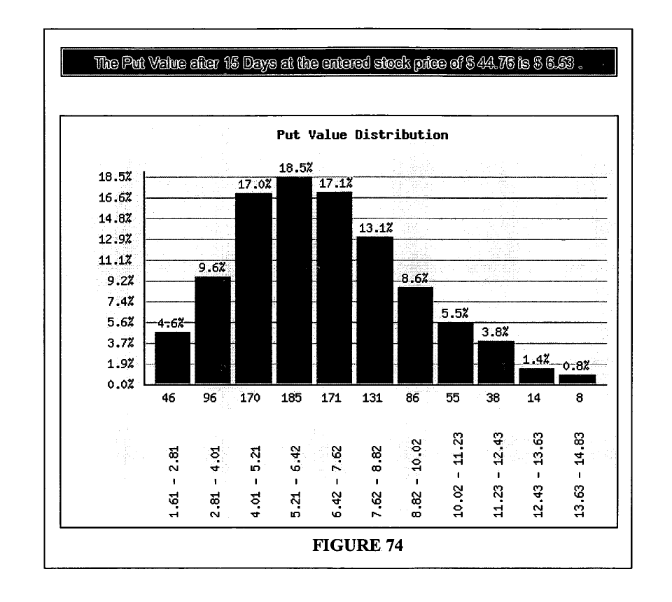

Step 3: The user observes the following results/output
The output presents the projected option value at the end of specified time-to-simulation period (refer to FIG. 71)
The graphical output presents, at the simulation date in the future:
   the call option price distribution in a bar chart format on the basis of the number of simulations specified (refer to FIG. 71)
   the projected stock price distribution in a bar chart format on the basis of the number of simulations specified (refer to FIG. 73)
   the put option price distribution in a bar chart format on the basis of the number of simulations specified (refer to FIG. 74)
The user can query the module to estimate the probability that the future call or put option price will equal, exceed or be under a specified amount (refer to FIG. 72)
The user can save the last simulation for later review.

Module 13. Gain/Loss Probability Estimator Module

The Gain/Loss Probability Estimator Module is stand-alone module that enables a user to estimate the chance of a specified gain or loss from a stock or portfolio investment.

The module estimates the beta-risk of a stock and determines the projected return as well as stock return volatility on the basis of historical data. It uses a probability (normal) distribution to estimate the chance of a specified gain or loss from an investment in a stock or a portfolio over a specified period. The user can select the beta estimation period.

This stand-alone module, which has been discussed as an integrated module under stock analysis (Module 4) and risk return tradeoff (Module 7) is also offered as a separate module. The user is required to enter all inputs: stock or portfolio volatility, stock or portfolio value, discount rate, amount of gain or loss and period over which the probability is to be measured. The output is a probability number expressed as a percent, with a maximum value of 100%. The stand-alone nature of the module enables a user to estimate probabilities of gains and losses for situations not covered under other modules and offers a generalized approach to loss probability estimation. The module continues to assume a normal return distribution.

Step 1: The module fills in the following inputs automatically (refer to FIG. 75)
Value of the stock or portfolio (7501)
Annualized mean of the distribution (7503)
Annualized volatility of the distribution (7504)

Step 2: The user selects/provides the following inputs
Specify the amount and choose Gain or Loss (7502)
Enter period length and specify type (7505).
Click on Submit button (7506)

Step 3: The user observes the following final result (refer to FIG. 76)
Estimate of probability of Gain or Loss (7601)

Module 14. Net Present Value Module

The Net Present Value Module allows a user to compute the attractiveness of a project or an investment on the basis of the net present value criterion, commonly used in investments and corporate finance.

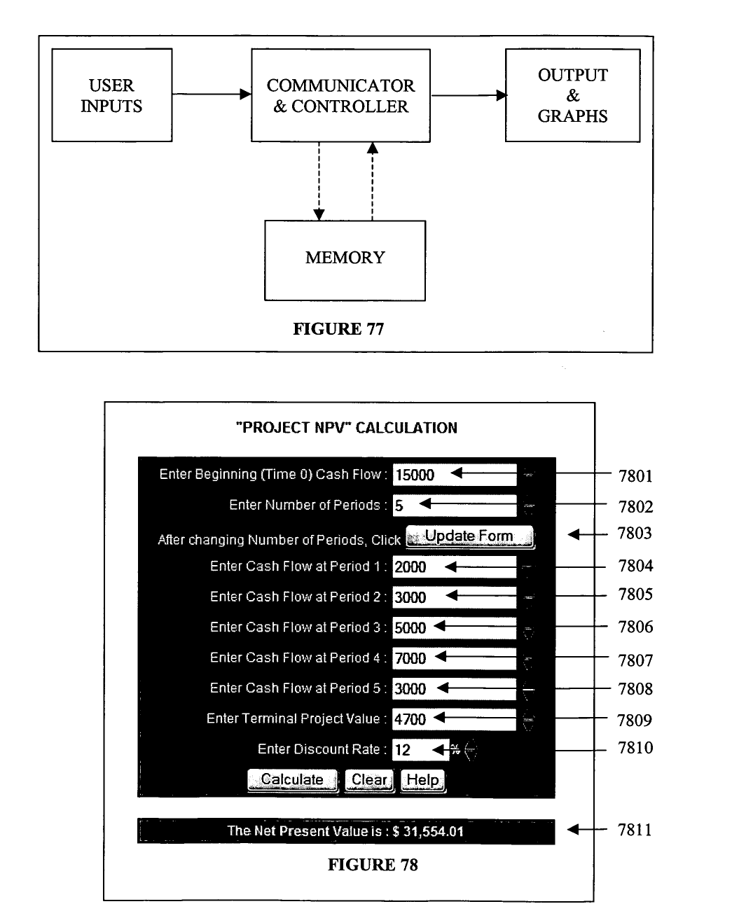

This simulator (refer to FIG. 77) computes the discounted values of future cash flows and sums them together after taking their signs into account, negative for outflows and positive for inflows. It requires cash flow and discount rate inputs from the user and produces results on the fly accompanied by a graphical output.

This module is a general module that enables analysis of a project on the basis of the net present value (NPV) criterion. After the user enters the necessary cash flows, current as well as those projected into the future, including a terminal value at the end of the horizon, discounted values are calculated and added across all cash flows, inflows as well as outflows. The net result is reported as the NPV. NPV values exceeding zero support an investment in a project. Negative values discourage investment in a project and zero values project a neutral stance. The output of the model is also presented graphically for visual appreciation and understanding. The formula used is given below:
NPV={Σ_{t=0 to T} [CFₜ/(1+k)^{t}]}+TV_{T}/(1+k)^{T}
Where CFₜ is the cash flow at time t, k is the discount rate, T is project's life and TV_{T} is the project's terminal value.

The NPV module can also be used by an investor to ascertain his or her net position over a holding period. In this case, purchase price can be entered as an outflow for the initial cash flow. Dividends or coupon payments can be entered as interim cash flows and the sale price can be entered as the terminal cash flow. After specifying a desired rate of return as the discount rate, the NPV of the investment over its holding period can be compared with zero and interpreted according to the rule described above. While this application assumes an after-the-fact computation, the module can also be used before an investment is made by entering projected cash flows and anticipated terminal or liquidation values. Negative interim cash flows are supported by the module for generalized applicability.

The user selects/provides the following inputs (refer to FIG. 78)
Beginning, time 0, cash flow—investment outflow (7801)
Number of future cash flows (periods) (7802)
Add additional periods if necessary, defaults to 5 (7803)
Amount and timing of every future cash flow (7804 to 7808)
Last period terminal value (7809)
Discount rate (7810)

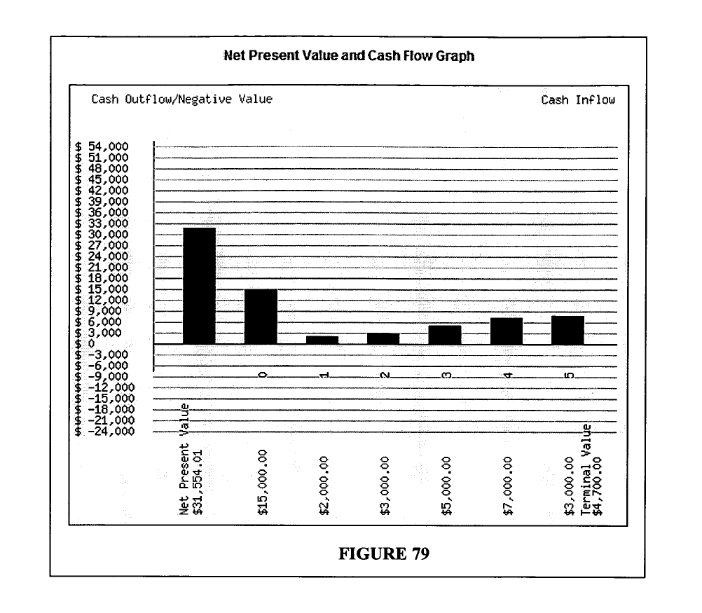

The user observes the following results/output (refer to FIGS. 78 & 79)
Net present value on the basis of cash flows and specified discount rate (7811)
Graph of all cash flows and terminal value on a time line (refer to FIG. 79)

Module 15. Investment Process for Portfolio Creation, Validation, Efficiency and Loss Tolerance Determination

The module guide the user investor in choosing an optimum portfolio in the risk return context starting with stock selection and ending with a finalized portfolio on the basis of integrated tools described above. This is a process encompassing several tools.

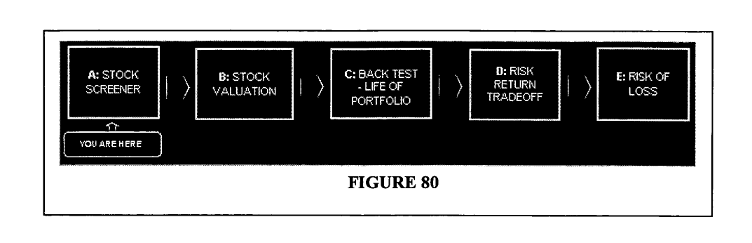

This process (refer to FIG. 80) assists an investor in identifying a portfolio that is diversified and is efficient (provides highest return for a given risk level) once an investor has identified investable stocks. It enables the user to estimate the extent and probability of potential loss and gain from the portfolio and compare it to his or her ability to tolerate projected risk and losses. It allows for extensive portfolio testing before investing with the help of historical stock price and returns data. Sensitivity and what-if analyses as well as simulations form the backbone of this method. It relies upon generally accepted financial principles of investing under a diversified portfolio regime.

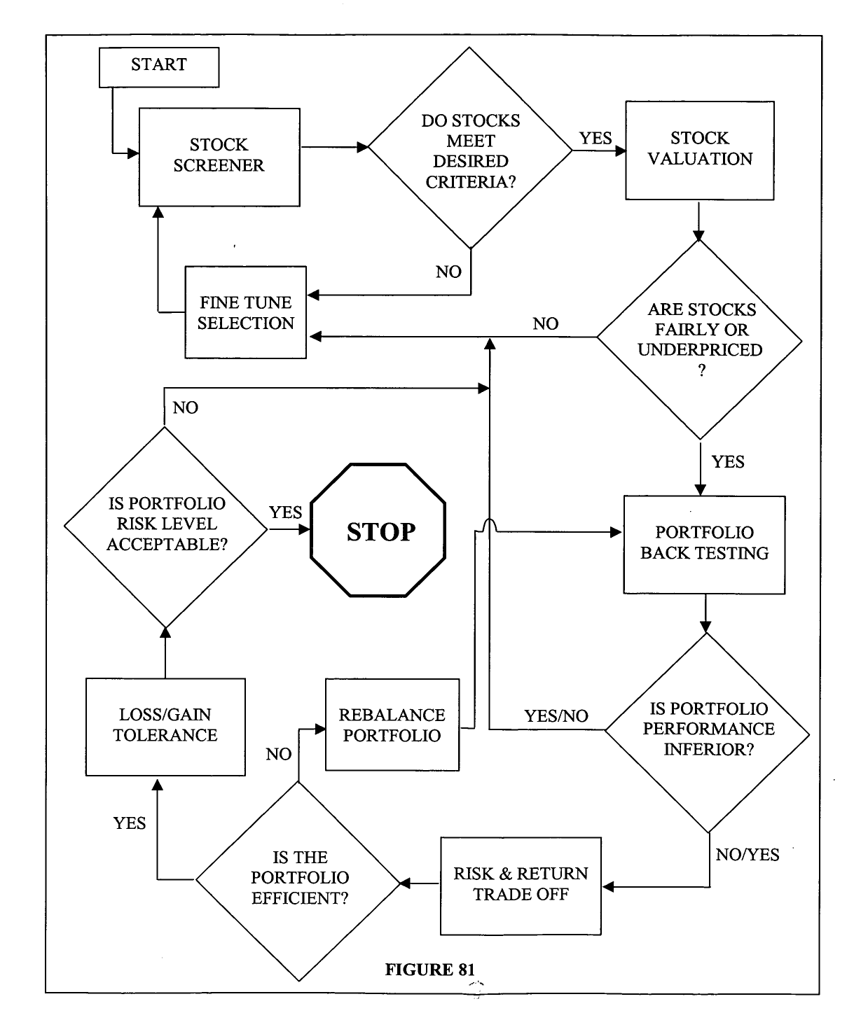

Additionally, the process involves a sequence of actions on the part of a user. Each action corresponds to executing a module. Modules are arranged in such a way that the output of one module can be used as an input for the next module. The goal of this process is to arrive at an optimum long term portfolio in the risk return framework. This process is laid out in detail in FIG. 81.

The user follows these steps with feedback:
Identify an initial list of stocks with the help of the stock screener.
Value each stock, if it pays dividends, on the basis of stock analysis tools for an understanding of embedded earnings growth in its stock price and overall attractiveness
Create a tentative portfolio based on the stock selection strategy employed in the stock screener in step 1 above
Back test the portfolio using software tool designed for this purpose
Measure the life of portfolio performance of the portfolio for consistency of performance. This tool can be used to compare the consistency of several different stock selection strategies in combination with the back testing tool
Conduct the risk return analysis with the software tool and understand its strengths and weaknesses in terms of projected return, efficiency and diversifiable risk
Compute the probability of gain or loss from this portfolio over the user's investment horizon
Rebalance the portfolio with the same stocks or introduce new tickers into the portfolio to alter its risk return profile and repeat the steps until desired portfolio characteristics are reached

The components of the diagram represent web based software tools and modules (Nos. 4, 6, 7 & 13) described and discussed in detail earlier.

The user arrives at the following results:
Given the set of stocks, a portfolio that offers the highest potential return at a given risk level (or, efficient portfolio)
Awareness of the extent of portfolio risk return tradeoff in comparison to a well diversified market index of user's choice
Awareness of diversified risk of the efficient portfolio
Awareness of the efficient portfolio beta risk
Awareness of projected return on the efficient portfolio
Awareness of the risk of specified loss or chance of specified gain on the efficient portfolio
Awareness of the contribution of each stock in the portfolio to the specified gain or loss

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method of financial portfolio management and analysis, said method comprising the steps of:
identifying an evaluation set of securities;
conducting back-testing and life-of portfolio performance on said evaluation set of securities;
determining a risk-return relationship for a simulated set of securities having the same selection of securities as the evaluation set, wherein the portfolio percentage weights of the simulated set is changed,
analyzing the simulated set of securities with differing allocations of securities in the simulated set to achieve a desired risk level at an estimated return in the future; and
determining a portfolio risk by estimating objective probability of a specified loss over a given period on the basis of distributional assumptions and a breakdown of loss according to the allocations of securities.

2. The method of claim 1, further comprising the step of providing a Stock Screener and Stock Valuation Module.

3. The method of claim 1, further comprising the step of providing a Portfolio Strategy Analysis Module.

4. The method of claim 1, further comprising the step of providing a Portfolio Risk Return Tradeoff Module.

5. The method of claim 1, further comprising the step of providing a Gain/Loss Probability Estimator Module.

6. A method of financial portfolio management and analysis, said method comprising the steps of:
identifying a set of options for valuation;
determining a volatility estimate for the set of options; and
determining future option values over a tenure of the options.

7. The method of claim 6, further comprising the step of determining a risk management potential for the set of options by combining them with a portfolio of stocks.

8. The method of claim 6, further comprising the step of determining a fair value of options.

9. The method of claim 6, further comprising the step of determining payoff scenarios with objective probabilities based on distributional assumptions for the underlying returns on the options.

10. The method of claim 6, further comprising the step of determining a likelihood of the option exceeding a target value in the future.

11. The method of claim 6, wherein the options are exchange traded or non-traded.

12. The method of claim 6, further comprising the step of providing an Option Valuation Module.

13. The method of claim 6, further comprising the step of providing an Option Volatility Module.

14. The method of claim 6, further comprising the step of providing a Forward Option Value Simulation with Probabilities Module.

15. The method of claim 6, further comprising the step of providing a Portfolio Strategy Analysis Module.

16. A method of financial portfolio management and analysis, said method comprising the steps of:
selecting a dataset sharing a common event or news release;
selecting a risk measure and market proxy for risk control;
analyzing of announcement, event or listing day effect as well as longitudinal post event average performance; and
repeating the preceding steps for several different investment strategies predicated on announcements, events and initial public offering segments.

17. The method of claim 16, further comprising the step of evaluating over a period of time a model portfolio implementing a strategy as determined by the preceding steps.

18. The method of claim 16, further comprising the step of providing an IPO Simulator Module.

19. The method of claim 16, further comprising the step of providing an Announcement Effect Simulator.

20. The method of claim 16, further comprising the step of providing a Event Effect Simulator.

21. The method of claim 16, further comprising the step of providing a Portfolio Strategy Analysis Module.

22. A method of financial portfolio management and analysis, said method comprising the steps of:
analyzing loans based on prevailing interest rates to gauge the benefit of refinancing a mortgage or a loan at lower rates;
analyzing bond yield to estimate the yield to maturity on an existing bond; and
determining interpretations of yields for an investor's portfolio holdings and return objectives.

23. The method of claim 22, further comprising the step calculating yields on callable bonds.

24. The method of claim 22, further comprising the step calculating holding period yields to determine lifetime return on a bond investment.

25. The method of claim 22, further comprising the step of providing a Loan Tool Module.

26. The method of claim 22, further comprising the step of providing a Lease Rate and Payment Module.

27. The method of claim 22, further comprising the step of providing a Bond Valuation Module.

28. A method of financial portfolio management and analysis, said method comprising the steps of:
estimating an annuity or single payment terms; and
determining invest or reject decision on the basis of risk adjusted time value computations.

29. The method of claim 28, further comprising the step of providing a Time Value of Money Module.

30. The method of claim 28, further comprising the step of providing a Net Present Value Module.
